(19) United States
(12) Patent Application Publication
(10) Pub. No.: US 2013/0317988 A1
(43) Pub. Date: Nov. 28, 2013

(54) PAYMENT AND ACCOUNT MANAGEMENT SYSTEM USING PICTOOVERLAY TECHNOLOGY

(71) Applicant: Ian A. R. Boyd, North Las Vegas, NV (US)

(72) Inventor: Ian A. R. Boyd, North Las Vegas, NV (US)

(21) Appl. No.: 13/830,210

(22) Filed: Mar. 14, 2013

Related U.S. Application Data
(60) Provisional application No. 61/652,306, filed on May 28, 2012.
(60) Provisional application No. 61/705,686, filed on Sep. 26, 2012.
(60) Provisional application No. 61/716,508, filed on Oct. 20, 2012.
(60) Provisional application No. 61/750,022, filed on Jan. 8, 2013.
(60) Provisional application No. 61/763,749, filed on Feb. 12, 2013.

(51) Int. Cl. G06Q 20/40

(52) U.S. Cl. CPC G06Q 20/4014
USPC 705/44

(57) ABSTRACT

A software application program on a computer platform uses PictoOverlay Technology to provide a completely unique and secure method of performing purchase transactions, accessing secure locations, or accessing email, websites, or downloading of min-apps or other software applications without entering, storing or transmitting personal identification information, or having a username and password to login. The uniquely developed PictoIdentity may associate an alphanumeric sequence with a series of static images and with a portion of one image from multiple layered dynamically presented images to for example access a financial account, perform financial transactions, login to a computer software program, access an email account, activate a mobile device, or enter a secure location.

### FIELD OF INVENTION

The present invention relates to a software application system and method for payment and account management to perform secure transactions without entering any personal identification information, login information or a password. The Payment and Account Management System is developed using PictoOverlay Technology and the PictoOverlay Interface to initiate and configure one or more digital PictoCash Accounts. The PictoCash Account is initially funded through a cash or monetary transaction that is then converted to a point or minute value referred to herein as PictoCash. A secure identification is created to access and use the PictoCash Account that may be used to pay for software and other consumer products, to transfer PictoCash from one PictoCash Account to another and to receive quasi-cash rewards from competitions and other rewards programs within the secure PictoCash Network.

The PictoCash Application Software further provides management tools for an Entity Management System to identify a device within the PictoCash Network using a secure identification referred to herein as the PictoIdentity. The Entity Management System may also review the amount of available funds within the account and administer transactions of crediting or debiting the account. The PictoCash Account is initially funded through a retail transaction performed by a network of PictoCash Retailers. The initial cash or monetary purchase is validated by the Entity Management System and is converted to an amount of PictoCash that is available to a user to purchase mini software applications, use minutes, or make retail purchases of consumer products from a group of Authorized Dealers. The Authorized Dealers may be managed through the PictoCash Entity Management System or have a separate system to offer software or other consumer products and accept PictoCash as payment for those products. Within the PictoCash Network, the PictoCash Account is specifically designed to monetize transactions involving the downloading and use of mini software applications or mini-apps, such as PictoPuzzles, PictoKids, PictoGames and other music, games, video downloadable software applications. These available products are managed and maintained by the PictoCash Entity Management System with each transaction requiring only the use of the PictoIdentity not the entering of any personal identification information, such as a login, password or credit card number.

The PictoCash Account is initiated through the retail purchase of an Access Code from an Authorized PictoCash Retailer that will be used to enter the PictoCash Application Software and setup a PictoCash Account. The monetary sum from this transaction minus transaction fees is forwarded from the PictoCash Retailer to the PictoCash Management Entity where it is converted to PictoCash. The monetary transfer of funds from the PictoCash Retailer to the PictoCash Management Entity is done through a bulk transfer of funds that does not include any individual transaction and does not link any personal identification information to any transaction. The PictoCash Management Entity is thereby restricted to a minimal number of customers consisting of the PictoCash Retailers with the conversion of funds to PictoCash only initiated after the User enters the purchased Access Code and sets up the PictoCash Account. The PictoCash Account is then tied to their computer, mobile or other electronic communications device with access and transactions only permitted using the PictoIdentity.

The present invention is not designed to permit cash exchanges or the refund of cash from the account but instead the PictoCash Account is maintained at minimal petty cash levels to permit the download and use of mini-apps or other software content. Additionally, Authorized Dealers within the PictoCash Network may accept PictoCash for retail purchases of consumer products, however any such purchases including any transaction that contains personal identification information would be within the administration and scope of an Authorized Dealer, and external to the PictoCash Management Entity.

In this way, the PictoOverlay Technology provides a completely unique and secure method of performing transactions without a User having a credit or ATM card, entering personal identification information, or having a username and password to login. The secure PictoIdentity may be used to gain access to operate and use an internet or wireless connection such as to enter and play a mini-app like a PictoPuzzle or other PictoGame on a computer, cell phone, smartphone or other electronic communications device. The completely unique access and validation system may also be used to securely access a computer software program, to upload or download content from an internet website, to access an email account, to activate a mobile device, to open a lock to enter a secure location, or to perform other secure transactions all applications of which are contemplated within the scope of the present invention.

The present invention applies the PictoOverlay Technology and PictoOverlay Interface to create a completely unique security system from features described as PictoGame Technology in U.S. Provisional Application No. 61/716,508, as the PictoStory Technology described in U.S. Provisional Application No. 61/705,686, and as the PictoKids Technology described in U.S. Provisional Application No. 61/750,022 which are each incorporated herein by reference. The PictoCash Application Software applies these technologies by structuring a quasi-monetary, time or point based account platform using the unique Architectural Blueprint to structure, edit and modify features of the PictoCash Account. The PictoCash Application Software security feature presents a unique PictoIdentity that combines choosing previously chosen static pictorial elements which then lead to the identifying a portion or Trans-Snip of a previously selected pictorial image. The portion of the identifiable pictorial image is presented within a dynamic layering of multiple images created using the PictoOverlay Technology within the PictoGame and PictoStory Software Applications which technologies transform pictorial images into animated musicked dynamic presentations to develop a significantly, improved secure access system, that prevents or reduces the requirement to provide personal information through an internet connection. Importantly, the PictoCash Software presents the PictoIdentity on even the smallest format cellular phone or electronic communications device where in identifying an image the User must only select an image from a touchscreen and telephone keypad. In instances where additional security is required, the User may be required to touchscreen or keypad two alphanumeric characters, as opposed to entering a complex series of numbers and letters to login, enter a password, or enter a credit card account number.

### BACKGROUND OF THE INVENTION

Protection of personal information is critical where an individual is continually accessing personal computers, mobile devices, and performing personal and financial transactions in retail stores or online with each requiring some type of identifying information such as a user name, a security code, or a password. For example, a sixteen digit credit card number, an expiration date and a three or four digit code must be either entered or verbally given to make a purchase through an internet website. Other requirements to login to a bank account or other financial site on a mobile device or personal computer require a user name, a password, the identification of a static picture and possibly the answer to one or more security questions to allow access.

One of the most prevalent security measures and least secure is the use of a four or five digit code to access an Automated Teller Machine (ATM) to obtain cash from a bank account using a pre-coded card. In these cases a burden is placed on the individual to physically have an active card, access a machine, remember a code, a password, a user name, an answer to an obscure question or physically have a credit card or other item to read a number off of. In other cases, the individual must rely on the security systems of the mobile device, the website, the computer system, or other security measures for protection of their personal identifying information, which without consistent maintenance and updating may not be adequate protection.

As an example, in a review of previously released and exposed tables and security breaches of four digit ATM codes that included over 3.4 million codes, 11% of these used the numbers 1234 and 26% of the codes could be guessed by attempting only 20 combinations of the four digit numbers demonstrating a general lack of imagination when consumers must select and remember a series of numbers or digits. The four digit code as well provides only about 10,000 combinations, therefore using a quite unsophisticated algorithm; the code of a stolen card may be quickly and easily obtained. In accessing a mobile device, personal computer or financial website guidelines for improved security suggest passwords that are longer, have both numbers and letters, have some letters capitalized and use special characters, such as @, !, #. The difficulty for a User occurs in remembering the sequence as the complexity increases and the time and relative difficulty of inputting the code on small handheld devices. For credit cards, the use of a physical card leaves a consumer open to fraud where prying eyes or listening ears may see or overhear a number and the security code or worse procure the card and use it as they wish. What is needed is a protection system that requires NO card, is secure, is easily remembered and identified by a consumer, that may be used to replace petty cash (or an applications payment method), is easy to use on a variety of electronic devices and has a security system that may be easily changed without a burden to the consumer to remember a complicated sequence of letters and numbers.

### BRIEF SUMMARY OF THE INVENTION

The PictoCash Software Application system and method of the present invention provides for the creation of a unique PictoIdentity, the development of one or more PictoCash Accounts, the management of the account balance and transactions, and the management of a Network of Authorized PictoCash Retailers and Dealers. An account may initially be funded through a purchase transaction from a local retailer that is within the Authorized PictoCash Retailer Network of the PictoCash Management Entity. The purchase provides a randomly generated twelve to fifteen digit code that permits access to the PictoCash Application Software to setup a PictoCash Account for a computer, smartphone, cellular phone, tablet or other electronic communications device. The value of the monetary sum of the purchase is converted to minutes or a point value referred to herein as PictoCash that funds the PictoCash Account. After the initial purchase transaction the funded PictoCash Account may be used for any number of payment or cash equivalent software downloads and transfer transactions.

Through the PictoCash Entity Management System transactions may be made using all or a portion of the PictoCash or a certain amount of minutes. Additional PictoCash may be added to the account through additional retail purchases, or through a transfer transaction with another PictoCash Account. Points may also be added in a variety of ways such as, for example, through an airline miles program, a purchase rewards program where every purchase over a certain amount adds points to the PictoCash account or through rewards for point scoring in one or more video games, such as by completing or achieving the highest score in a PictoGame as described in U.S. Provisional Application No. 61/716,508. The account may further be used for phone or internet access minutes to play a PictoGame or other mini software applications. Through the Authorized Dealer Network PictoCash from the account may also be used to purchase consumer products.

Central to the system is that NO personal information must be entered to complete the transaction and NO personal information is associated with or transmitted with any transaction. Instead the PictoCash Account information is associated with a specific device that is then encrypted and is then verified using an exclusive variable PictoIdentity. The PictoCash Account information with the PictoIdentity is linked to the electronic communications device not to a User's personal information, therefore the PictoCash Account may be restricted to and may only be accessed from that specific device. For a separate device the User must setup a separate PictoCash Account with a separate PictoIdentity and transfer funds from one device to another if desired.

In a first embodiment, the PictoIdentity is developed by the User by first optionally having to choose a letter or number from an alphanumeric block that may have the twenty-six letters of the English alphabet and the digits 0-9. The User must then by using PictoOverlay Interface choose a Major Theme, a Sub-Theme and a Sub-Topic. The Major Themes are presented in a Montage Page that displays a set of nine labeled pictures in a 3×3 format with the center picture labeled as a general Major Theme with a combined picture of the surrounding labeled pictures. The User chooses one of the nine labeled pictures. A second Montage Page showing labeled pictures for the Sub-Theme is displayed for the User to choose from. The User chooses one of the Sub-Theme labeled pictures. The Sub-Topic Montage Page may then be displayed with nine labeled pictures and the User chooses a Sub-Topic labeled picture from these. Each of the labeled Sub-Theme and Sub-Topic pictures may be related to one of each of the Major Themes, in this way, the User may associate the label with the picture and thereby more easily remember their chosen Major Theme, Sub-Theme and Sub-Topic. The pictures may instead be more general such as pictures of people in different occupations, animals, cars, objects or of anything else. The User is free to choose any one of the pictures for a Major Theme, a Sub-Theme and a Sub-Topic. Through these choices of a number or letter and the Major Theme, Sub-Theme and Sub-Topic, the complexity in combinations of this first portion of the PictoIdentity is significant, meaning that anyone that is trying to guess someone's PictoIdentity would have to go through 36×8×8×8 or over 18,000 combinations with the picture choices alone presenting 512 separate possibilities.

A next step in creating the PictoIdentity is the selecting of a picture that is completely unique to the User. The image is selected from one or more Montage Pages and may be an image that is related to the Major Theme, Sub-Theme or Sub-Topic or may be a totally random picture. While the identification of a picture or image as a security measure may be known in the prior art, the present invention does not simply present a static image that a prying eye may view and remember, instead using the PictoOverlay Technology, the selected Image is stylized to create a number of partial images or Trans-Snips of the selected Image. Using the PictoOverlay Technology, a Trans-Snip created from the Selected Identifiable Image is used within the PictoPuzzle. To complete the PictoIdentity, the User must be able to select and identify even a portion of their selected Image within the PictoIdentity PictoPuzzle as described in greater detail herein. In accessing the PictoCash Account or performing a transaction, the User must complete their PictoIdentity by choosing their alphanumeric choice, their chosen Major Theme, their chosen Sub-Theme, and their Sub-Topic. The PictoIdentity PictoPuzzle is then displayed with a series of randomly generated Trans-Snip layers that are presented in a delayed fashion to provide time for the User to easily identify their selected Image and complete the PictoIdentity. The PictoIdentity may be configured and any number of varied formats and structures using the Theme Montage Pages and PictoIdentity PictoPuzzle with the complexity increased based upon the requirements of the security measures. Upon completion of the PictoIdentity, a software download, a transfer of funds or another transaction that accepts PictoCash in payment may be completed or the lock to a building, a car or other secure location may be opened.

In an embodiment of the PictoCash Account, upon initial registration within the PictoCash Network the computer, mobile or other electronic device is associated with the PictoIdentity in an encrypted format and thereafter transactions within the Network can be performed. Importantly, the PictoIdentity can be completed by using only a telephone keypad on a smaller format cellular telephone and by picking one of the number keys to select the chosen PictoIdentity letter or number. The Major Theme, Sub-Theme, and Sub-Topic may be chosen by picking a number on the keypad, where the number 1 would correspond to the picture in the upper left quadrant, the center picture would be number 5, the lower right quadrant would be number 9, and so forth. The PictoIdentity may also be completed using any type of pointer device, a touch screen, or a keypad. The PictoIdentity may therefore be registered within the PictoCash Entity Management System in an encrypted format as a series of letters of numbers that correspond to chosen letter or number and the location of the chosen Major Theme, Sub-Theme, and Sub-Topic pictures. The pointer device, touch screen, telephone keypad or keypad may also be used to select the Identifiable Image within the PictoPuzzle with the Selected Identifiable Image registered with the PictoCash Entity Management System through an encrypted format using the location and layer position of the Trans-Snip within the PictoPuzzle. Importantly, the choices for the PictoIdentity are never recorded on the electronic device associated with the PictoCash Account but instead only an encrypted code that represents these choices is stored, with the decryption available only through the PictoCash Entity Management System.

The PictoIdentity may therefore be required to download software, access a website or to continue playing a software application or mini-app on the PictoCash Network. The transaction may transfer a sum of PictoCash or minutes to the PictoCash Account to pay for or to continue playing the mini-app or PictoGame. A transfer to the PictoCash Account is completed through a request by the User to the PictoCash Management Entity for a transfer code that the User may enter in another PictoCash Account or email to another PictoCash Account User to enter into their account. The PictoCash Management Entity issues the transfer code to the User funds and immediately transfers funds to the PictoCash Central Repository of the Management Entity. Upon entering the transfer code, the funds are transferred from the PictoCash Central Repository to that PictoCash Account. Importantly, the transfer transaction is validated by the PictoCash Management Entity and through this validation the PictoCash Transfer Code may be used only once and then is blocked from reentry.

The PictoIdentity and linking of the account to the device provides an unmatched level of protection from thieves, hackers or other nefarious types that wish access to the account. Clearly personal information can never be obtained because it is not in any way associated with the PictoCash Account and may not even exist on the electronic device. The PictoCash Account is also not registered or associated with the Authorized PictoCash Retailer from the initial purchase that generated the secure Access Code to setup the account and therefore any personal information obtained by the retailer in the transaction is also not transferred to the PictoCash Management Entity. The PictoCash Account also does not require any login, password, physical card, or proof of identification. The User must simply remember their unique PictoIdentity to access the PictoCash Account or complete the correct PictoIdentity when downloading or using software applications on the PictoCash Network to purchase time or a mini-app. The PictoCash Account further does not require any proof of payment, where payments are made by automatically transferring funds to the secure PictoCash Network by entering the proper PictoIdentity. The PictoCash Account may further be limited to petty cash amounts removing tax implications related to fund transfers.

Payment and transfer transactions at every level would benefit from this improved security measure where a user is not required to enter any identifying information, but instead access and verification of transactions are only granted by the User completing their totally unique PictoIdentity. The PictoIdentity Security Technology may further be used in the place of door locks for homes, businesses or automobiles where multiple users may each have an easily configured series of chosen pictures and a completely unique Selected Identifiable Image that is dynamically presented in an ever changing PictoPuzzle that when identified will unlock a bolt or barrier to gain admittance. Administrative tools within the PictoCash Application Software also provide for a PictoIdentity to be added or deleted to monitor and control access where immediate blocking or modification to access may be required.

### The Enhanced Multi-Dimensional PictoCash Software Modules A, B, C

The Enhanced Multi-Dimensional PictoCash Software Application is comprised of three Modules; A, B and C that establish and maintain a PictoCash Account to perform payments and transfer transactions within a secure PictoCash Network. To access and perform transactions within the PictoCash Account a unique and secure PictoIdentity is created. The PictoCash Account associates a time or point based value with an electronic device without the association of any personal identification information and these funds within the account may be used to upload or download content, access an online software application, access minutes for the use of a mobile phone, internet or wireless connection, or compete with others through an internet connection to receive rewards.

### The Multi-Dimensional Enhancement Features of the PictoCash Application Software

The Enhanced Multi-Dimensional PictoCash Application Software is described as Multi-Dimensional because as part of the identification process a PictoPuzzle is presented, as previously described in other patents, Multi-Dimensionally which refers to the multiple layered Composite Images included within the Collage Images and Enhancements used for development of the PictoIdentity and for features within the PictoCash Account. A first dimension of the software is the alphanumeric block that is presented to initialize the PictoIdentity. A second dimension may be the static two-dimensional pictorial images that must be chosen for the Major Theme, Sub-Themes, and the Selected Identifiable Image that is selected and formatted to form a series of Trans-Snips that are used within the PictoIdentity PictoPuzzle. A third dimension may be a layered three dimensional image formed from a number of layered Trans-Snips that include a Trans-Snip from the Selected Identifiable Image. A fourth dimension is the addition of time and sequential relationships using Dynamic HTML, macros and other software scripts to order and display the layered Composite Images and dynamically present the PictoIdentity PictoPuzzle. A fifth dimension is the rendering of a series of PictoStorys from multiple PictoLayers to form other features of the PictoCash Account. A sixth dimension is an infinitely variable set of Enhancements that provide instruction, data entry, verbal commands, action, movement and depth to the PictoLayers of the PictoCash Account and PictoIdentity. In point of fact, Enhancements may be seen as extending the PictoLayers beyond the four normally used dimensions, of X, Y, Z coordinates and time and into many-dimensions. Within each dimensional level, a Blueprint Page is formed that includes access to all of the Components, Sub-Components and Enhancements of the PictoLayers that are each accessible within a totally unique Architectural Blueprint that structurally formats the features of PictoCash Application Software.

### Module A: PictoIdentity and Instructional Presentations

The function of Module A is the creation of the PictoIdentity and the structural formation of the Architectural Blueprint to randomize and vary the PictoLayers of the PictoIdentity to create an infinite number of PictoIdentity PictoPuzzles. Module A also includes an Intro-Explain-Navigate Generator that creates one or more film-like presentations and controls that provide an Introduction, an Explanation, and Navigational Instruction about how to create and use the PictoIdentity and PictoCash Account. These Enhanced Multi-Dimensional Presentations are developed from a series of Sequenced PictoStorys and are short and comprehensive instruction to provide a User with all the information necessary to create a PictoIdentity, to setup a PictoCash Account and to perform transactions.

### Module A: The PictoIdentity

Using the PictoIdentity, the PictoCash Software Application establishes an unmatched approach to the protection of personal information. A unique, personal PictoIdentity is created by a User from either a series of letters or numbers and then chosen labeled pictures that represent a Major Theme, Sub-Theme and Sub-Topic. The PictoIdentity is completed with the selection of an Identifiable Image or portion thereof that is dynamically presented within a PictoIdentity PictoPuzzle that allows a User to select the Trans-Snip by sliding, touching, tapping or by using a mouse or other pointer device. The PictoIdentity developed using the PictoOverlay Technologies reduces the threat of cracking the User's unique PictoIdentity by increasing the complexity of a simple four digit code that has roughly 10000 combinations and is commonly used for ATM access to a more secure, more easily remembered code of hundreds of thousands combinations.

In a first embodiment, to create the PictoIdentity, Module A of the PictoCash Software Application develops an Alphanumeric Block, a set of Theme Montage Pages and a series of Image Montage Pages that are used to present the Identifiable Image presented as a Trans-Snip PictoLayer within a PictoPuzzle. Using a PictoPuzzle Generator, the Montage Pages are structured with the pictures representing the Major Themes, Sub-Themes and Sub-Topics. The Montage Page format is commonly used to present other features of the PictoCash Account. The pictures used in the Montage Pages are stored in a Variable Output Folder in a Data Store Resource of the PictoCash Application Software. The PictoIdentity is created by a User by selecting one or more numbers, one or more letters, a set of static pictures and the Selected Identifiable Image. In this embodiment of the PictoIdentity, these choices represent over 18,000 possible combinations and by developing Trans-Snips of the Selected Identifiable Image and using these in randomly developed PictoIdentity PictoPuzzles the possibilities become infinite where the Trans-Snip may always be changing as well as each of the PictoLayers within the PictoPuzzle. Various Enhancements may be incorporated to present audio, video, slide, animation, interactive features, effects and other media, to change the presentation and display of the PictoIdentity PictoPuzzle. The Enhancements may play a sound when the correct PictoIdentity is entered, or play a buzzer for a PictoIdentity incorrectly identified, or turn off the display or close a software program if the PictoIdentity is repeatedly entered incorrectly. Enhancements may further provide a verbal recording of the current account balance or other alerts or notices about the PictoCash Account.

### Module A: Configuration of Data Store Resource for the PictoIdentity

In an initial step, a Data Store Resource is developed with a Coordinate File Naming System that reflects the layered coordinate system of the Referenced Page Map of a structurally formatted Architectural Blueprint. In this way the PictoLayers and their Components and Sub-Components of the PictoIdentity and PictoCash Account are stored within the Data Store Resource at specific coordinate system locations with encrypted file names matching their positions and locations within the Architectural Blueprint. This file naming and storing structure provides for a distinct X, Y and Z coordinate location of each PictoLayer and their Components and Sub-Components for the PictoIdentity and for other features in the PictoCash Account. The X and Y positions are column and row locations within the Referenced Page Map and the Z coordinate refers to the layer of the PictoLayer. For example, a Collage Image for the PictoIdentity PictoPuzzle may be made up of multiple PictoLayers that are formed from multiple layers of Composite Images and Trans-Snips so a first Trans-Snip layer within the Composite Image may have a Z coordinate of 3 referring to the Tran-Snip that is positioned as the third layer in forming the Composite Image.

### Module A: PictoIdentity—PictoPuzzle Generator

The selection of PictoLayers that may be used in the PictoIdentity and stored in the Data Store Resource is performed using the PictoPuzzle Generator. The PictoPuzzle Generator groups a series of PictoLayers, Composite Images, and Trans-Snips that may be randomly selected. Selected PictoLayers are stored within an Active Output Folder within the Data Store Resource. The Variable Output Folder mirrors the Coordinate Filing Naming System of the Architectural Blueprint and selected PictoLayers are stored and renamed using an encrypted code associated with this File Naming System format. Importantly, these PictoLayers have already been categorized and indexed within the Data Store Resource in General Folders related to specific Themes and Sub-Themes. The PictoPuzzle Generator scans the General Topic Index and renames selected files using the encrypted code of the Coordinate Filing Naming System thereby developing a library of tens of thousands of PictoLayers that may be used in the PictoIdentity PictoPuzzle.

PictoLayers that are not used are stored within the Variable Output Folder as Alternative PictoLayers that may be used to randomly replace PictoLayers in the PictoIdentity to produce an ever changing Collage Image that includes a Trans-Snip of the Selected Identifiable Image selected by the User. Within the random selection of PictoLayers, the User must recognize and acknowledge this Selected Identifiable Image or portion thereof. The PictoPuzzle Generator further structures a random or partially random set of PictoLayers within a series of Montage Pages to display pictorial images for the User to choose for the Selected Identifiable Image that will be used in their unique PictoIdentity.

### Module A: Intro-Explain-Navigate Generator

The Intro-Explain-Navigate Generator of Module A also creates one or more film-like presentations using PictoOverlay Technology as described herein and in the previously filed PictoStory, PictoKids and PictoGame patent applications. These Instructional Presentations provide an Introduction, an Explanation, and Navigational Instruction about the creation of the PictoIdentity, setting up a PictoCash Account and explaining how to perform transactions within the PictoCash Network. These Enhanced Multi-Dimensional Presentations are developed from a series of PictoStorys and are short, engaging, and comprehensive instruction to provide a user with all the information necessary to use the PictoCash Account features.

### Module A: Enhanced Multi-Dimensional Introduction Presentation

Module A creates an Enhanced Multi-Dimensional Introduction Presentation that quickly and easily presents the general context of creating a personal identification code. The Introduction visually demonstrates that by choosing a combination of pictures, numbers or letters and a special image unique to the User a secure, unique PictoIdentity may be created. The User may also select optional Enhancements such as a sound or a visual display that chimes or appears, when a correct PictoIdentity is entered or a mistake in the PictoIdentity is made. This short, visually engaging film-like presentation immediately provides to the User the features and objectives of the PictoIdentity. Other features of the PictoCash Account are also presented within the Introduction Presentation.

### Module A: Enhanced Multi-Dimensional Explanation Presentation

The Intro-Explain-Navigate Generator also creates an Explanation Presentation from a series of PictoStorys to provide further information on using the control buttons and other system features associated with the PictoIdentity and PictoCash Account. The presentation demonstrates, “How to download and pay for a mini-app such as a PictoGame or perform a transfer of funds . . . ” to clearly and efficiently show the user how to use each feature and control of the PictoCash Account. A PictoCash Account on each type of device may have a series of common control buttons with an additional variety of controls provided for other devices, such as features for a basic cellular phone may be different than the features on a personal computer, with each of the controls and features properly sized and accessible for specific device.

### Module A: Enhanced Multi-Dimensional Navigator Presentation

The Intro-Explain-Navigate Generator further creates a dynamic Navigation presentation that displays a set of mini-apps, music, or other downloadable features that are offered within the PictoCash Network. The PictoOverlay Interface provides access links to present using the Montage Page format and structure a matrix of rows and columns of pictures. The Montage Page provides a navigation wall or board for a User to select a mini-app within the Network to download, transfer funds from one PictoCash Account to another, or perform other transactions. The Montage Pages are constructed within Module A in, for example, a 3×3 matrix format using three rows and three columns providing nine access links and nine subset links to choose from. The access and subset links of the PictoOverlay Interface may link to any point within the Network with an access link for example noting a particular type of mini-app for purchase, and the subset links presenting versions of the mini-app, such as PictoPuzzles at different levels of difficulty. The Navigator Presentation visually presents the selection of access links from the Montage Page and how to navigate to the subset links. Module A creates the short comprehensive dynamic Multi-Dimensional Introduction, Explanation and Navigation Presentations to draw the User in and fully and efficiently explain the setup, features, and transactions of the PictoCash Account.

### Module B—PictoCash Account and Management Entity

Module B includes the structured Architectural Blueprint, a Random Generator to vary the presentation of the Collage Images within the PictoIdentity PictoPuzzle, management of the individual User's PictoCash Account and management of transactions with the Authorized PictoCash Retailers and Authorized Dealers within the PictoCash Network. The structured Architectural Blueprint provides the layout and workspace for the PictoCash Management Entity to register a device on the PictoCash Network, validate and approve transactions, and initially fund the PictoCash Account from the Authorized PictoCash Retailers without receiving any personal information about the User's that has the PictoCash Account.

### Module B: PictoIdentity—Random Generator

A Random Generator within the PictoCash Production Control Tools of Module B provides for the Collage Images, PictoStorys, Composite Images and Trans-Snips and other PictoLayers and Enhancements to be automatically replaced with Alternative PictoLayers within the Architectural Blueprint. The Alternative PictoLayers are selected from the categorized and indexed PictoLayers within the Variable Output Folder of the Data Store Resource. Each time a PictoIdentity is required to provide access to a PictoCash Account transaction, the random selection of a number of Alternative PictoLayers and a transition to Alternative Enhancements presents a completely new and unique PictoPuzzle within the PictoIdentity that contains a Trans-Snip of the User Selected Identifiable Image. The replacement is seamless where one or more Interchangeable PictoLayers and Enhancements within the Collage Image are immediately replaced by accessing and re-naming the Alternative PictoLayers with the encrypted coordinate file name matching the grid position of the Interchangeable PictoLayers within the Blueprint and moving the Alternative PictoLayer into the Output File Folder. The Collage Image within the PictoIdentity PictoPuzzle is immediately changed and Enhancements associated with the Alternative PictoLayers are immediately activated.

This automatic immediate replacement of the PictoLayers also replaces all of the Components and Sub-Component associated with the PictoLayers without the necessity of re-writing of code or recompiling of the PictoCash Software Application. This efficient and seamless replacement provides for an infinite set of PictoLayers and Enhancements to be presented within the PictoIdentity PictoPuzzle to further secure access to the PictoCash Account. The Alternative PictoLayers and Enhancements may replace an Interchangeable PictoLayer at any time continually introducing new features and preventing a User from ever seeing the same PictoIdentity PictoPuzzle more than once.

### Module B: Blueprint Generator and Architectural Blueprint

An important function of the PictoCash Application Software is the structural formation of the Architectural Blueprint for the creation of the PictoIdentity and PictoCash Account. The Architectural Blueprint is a completely different approach to the development and activation of a software application. This approach provides for automatic and immediate modification of the Trans-Snip layers within the PictoIdentity PictoPuzzle and features within the application without re-writing or re-compiling of software. Alternative Trans-Snips with different Pictorial Elements and Enhancements seamlessly replace the layered Trans-Snips within the PictoIdentity to continually change the images so that the presented PictoIdentity PictoPuzzle is never the same. Within each newly created Collage Image a Trans-Snip of the User's Selected Identifiable Image is partially hidden and must be selected by the User. By randomizing the PictoLayers that make up the Collage Image an infinite number of PictoIdentity PictoPuzzles are presented to the User but because only the User knows their unique alphanumeric and pictorial Theme sequence and their Selected Identifiable Image unauthorized access to the PictoCash Account is prevented.

Initially, the Architectural Blueprint is a blank workspace that is used to structure the layout of a PictoIdentity PictoStory that with Enhancements will present the Montage Pages that require input from the User to create a PictoIdentity. The Blueprint Generator structures an encrypted Coordinate File Naming System within the Architectural Blueprint to store the PictoLayers of the PictoIdentity and to randomly move the PictoLayers to different positions to create the infinite number of PictoIdentity PictoPuzzles. The Theme Montage Pages are also defined within the Architectural Blueprint by populating the Blueprint with pictures representing the Major Themes, Sub-Themes and Sub-Topics. The Blueprint is also populated with the Alphanumeric Block that includes letters and numbers for the PictoIdentity and the Image Selector Montage Page that includes a set of pictorial images for the User to select for their Selected Identifiable Image for the PictoIdentity. Within the Architectural Blueprint of Module B, the selection by the User is stylized to form the series of Trans-Snips that will be used in the PictoIdentity PictoPuzzle as described herein. The Architectural Blueprint also includes a Referenced Page Map that does not require scrolling or pull down menus to select and navigate, but instead is navigated through by zooming out from or into the Map to select features within the Blueprint.

### Module B: PictoCash User Account Management

The PictoCash Application Software also uses the innovative Architectural Blueprint to structure and format the layout of the controls and features of the PictoCash Account. Using the PictoOverlay Technology of the PictoStory Software Application described in U.S. Provisional Application No. 61/705,686, a series of Composite Images are formed to produce control features to view the PictoCash Account balance, to request a transfer of funds, to receive rewards or penalties that increase or decrease the PictoCash Account balance and to make payments for mini-apps or other products available on the PictoCash Network. The Composite Images form the PictoCash Account PictoStory Blueprint and are enhanced using the Enhancement Generator to present these features to the User and receive input or present further information about the PictoCash Account.

Account balances and transfers are continual tracked and verified by the PictoCash Entity Management System. The initial transaction to setup the PictoCash Account involves the purchase of, for example, a 12 digit Access Code and the conversion of the monetary amount to a number of minutes or PictoCash points within the PictoCash Account. The Access Code may be entered only once and is then blocked from re-entry by the PictoCash Entity Management System. The Access Code may however be entered on any device, and since personal information is not contained or associated with the code, a loss of the code does not prevent another. User from entering the code and gaining the PictoCash. Similarly in a transfer of funds a transfer code and amount for the transfer is managed through the PictoCash Entity Management System that generates a Transfer Code for the User to forward to another PictoCash Account User. Upon generating the Transfer Code, the PictoCash is immediately withdrawn from the User's PictoCash Account and stored by the PictoCash Management Entity in a PictoCash Central Repository to be redistributed to another PictoCash Account upon entering of the Transfer Code. The User may email the code or enter the code on another device to have the PictoCash transferred from the PictoCash Central Repository. The generation of the transfer codes and each of the User's transactions are validated by the Entity Management System, and if a transaction exceeds the available funds of PictoCash within the PictoCash Account the Entity Management System does not generate the transfer code and the User is notified and instructed to replenish the amount in order to complete the transaction.

### Module B: PictoCash Entity Management System

Module B also provides the PictoCash Application Software for the PictoCash Entity Management System to perform three principal functions in management of a User's PictoCash Account. These are; (1) to validate the Access Code provided in a retail sale and convert the sale to a PictoCash amount in the User's PictoCash Account; (2) to approve and maintain the Authorized PictoCash Retailers within the PictoCash Network and receive money from the Authorized PictoCash Retailers for each retail sale; and (3) to manage the Authorized Dealers and maintain the PictoGames, mini-app and other available consumer products for sale within the PictoCash Network. The monetary conversion for the PictoCash points or minutes is configured within the PictoCash Entity Management System to convert the cash received by the Authorized Retailer in the retail purchase to an amount of PictoCash or minutes that a User may use for access time or to pay for to play or use the mini-apps and other products available on the PictoCash Network. The User's personal information from the retail transaction is never associated with the retail purchase or the PictoCash Account and is never given to the PictoCash Entity Management System. The PictoCash Account is only accessed using the User's personal PictoIdentity not a login name or password, thereby reducing or preventing the requirement to repeatedly enter personal or credit card information to make a payment or perform a transaction. Using the Production Control Tools, the Entity Management System also creates, enhances, populates and modifies features of the PictoCash Application or another application that is being serviced, used, or paid for, through an Authorized Dealer including tools for choice, download and upload of the requested application.

The PictoCash Account is integrated within the PictoCash Network and the Network restricts the mini-apps and products available for download or purchase. The Entity Management System may also manage competitions within the Network for particular PictoGames or other mini-apps that provide for a User to obtain rewards through incentives, or penalties for example through point scoring in a series of video games to increase or decrease balances or minutes in their PictoCash Account. Unlike current online line banking or personal use accounts such as PayPal, the Network and secure PictoIdentity used for each transaction allows only for the conversion of money to points or minutes into the account, or the transfer of points or minutes from the account. The PictoCash Account does not support the refunding or conversion of points to currency in any type of cash payout. Once the PictoCash is obtained, it may only be used to pay for mini-apps or other downloadable products within the secure PictoCash Network. The balances are therefore maintained at minimal “petty cash” amounts that should be in low enough numbers to not create a tax burden or governmental concern.

### Module B: Production Populator

Module B also includes a Production Populator that populates the Architectural Blueprint with content libraries, additions, modifications and other content transfer options for the mini-apps and other products available on the PictoCash Network. In addition, Module B provides the form and structure for an Enhancements Generator that configures and associates Enhancements with the PictoLayers; an Encryption Generator that encrypts the User's PictoIdentity and any necessary transaction information; and a Network Generator that adds Authorized Dealers to the PictoCash Network. Module B also includes a Process Controller that develops and activates the actions and process steps that are performed to render and present the PictoCash Account in Module C.

Using the Architectural Blueprint, the PictoCash Production Control Software of Module B configures the layout, format and the relationships between each of the PictoLayer Components and Sub-Components for the PictoCash Account. These PictoLayers are all structured within the Referenced Page Map of the Architectural Blueprint creating a work space to create, enhance and modify the PictoCash Account. The Production Control Tools of Module B include a Production Populator and a Process Controller that develop the Graphical User Interface (GUI) and renders the features of the PictoCash Account active. The GUI includes the control tools, dialog boxes, screen layouts and sequences that the User sees and operates for the PictoCash Account.

### Module B: Enhancements Generator

Each selected PictoLayer may further be enhanced using the Enhancements Generator to associate action, sound, and visual effects for the PictoIdentity PictoPuzzle and to create the functions for setting up the PictoCash Account, performing transactions, and transferring funds. Enhancements, using Dynamic-HTML (D-HTML), subroutines, macros and other coded scripts, vibrantly transform the PictoLayers of the PictoStorys and Collage Images. Using the Enhancements Generator and the noted software applications, the PictoIdentity and each Pictolayer may be transformed to provide audio and video instruction to use the PictoCash Account and perform transactions using the account. Dialog boxes, data entry forms, graphical selection pointers that are selected with movement of the mouse or other device or through the selection of the pointer on a touch screen may all be used to perform transactions. The Enhancements may further provide for verbal instruction, visual indicators or Multi-Dimensional Film-Like Presentations to present and advertise mini-apps and other products, software or other applications that may be purchased and downloaded from the PictoCash Network. The Enhancements may be visual, textual, audio, narration, musical, or in any other format. Enhancements may also be associated with the Collage Image or any Component or Sub-Components of a PictoLayer to sequentially order or re-order, add background-music, audio and visual effects, movement, and other features to the PictoLayer.

### Module B: PictoCash Account Production Tools

After categorizing and indexing the PictoLayers, populating the PictoCash Architectural Blueprint, and configuring for Alternative PictoLayers that are used for the PictoIdentity, the Process Control System Tools are developed for the User to setup a PictoIdentity and use the PictoCash Account. The Process Controller within Module B configures the interaction required by the User to setup the PictoCash Account, to perform payment transactions to purchase and download software applications and other products, and receive rewards to increase account balances, transfer funds or perform other transactions. The Process Control System Tools may further link a PictoGame or other software video game point total to a PictoCash Account through a competition or other reward program. Within the Architectural Blueprint, the Process Control System Tools perform all of the steps necessary to create, arrange, modify, enhance, and edit the PictoLayers and activate the PictoCash Account for the features within Module C to present the PictoCash Account to the User.

### Module C: The PictoCash Account Presenters

Module C uses the features of Modules A and B to provide the User with the Introduction/Explanation/Navigator film-like presentations. A review of these presentations allows the User to rapidly understand how to create the PictoIdentity and use the PictoCash Account including instructions to access any related application. In initially setting up the PictoCash Account, the User using the PictoOverlay Interface is prompted to select the Identifiable Image that will be displayed as a Trans-Snip in the PictoIdentity PictoPuzzle. The User is prompted to choose one or more numbers or letters from the Alphanumeric Block. The Major Theme Montage Page is then presented for the User to choose a labeled picture that represents a Theme such as a location, career, or activity. The User then must choose a Sub-Theme and a Sub-Topic that in this way instead of remembering a series of numbers similar to an ATM code or a series of numbers and letters similar to a password, which are each limited in complexity based on the User's skills in remembering, the User instead may much more easily remember a series of pictures that must similarly be chosen in the proper sequence. The User must then also acknowledge their Selected Identifiable Image or a portion of the Image shown as a Trans-Snip that is dynamically presented in the PictoIdentity PictoPuzzle to properly complete the PictoIdentity. The PictoPuzzle may slowly present each layered Trans-Snip displaying each for a second or two for the User to clearly recognize their Selected Identifiable Image within the Collage Image of the PictoPuzzle. The User must then identify the Image using a touch screen, pointer device, or other mechanism to select the Trans-Snip within the PictoPuzzle of the Selected Identifiable Image. In making four choices of an alphanumeric choice of 1 out of 26 letters and 10 numbers, and three choices from the Theme Montage Pages that each present 8 images the variation in this first portion of the PictoIdentity is over 18,000 and by then combining these options with the infinitely variable PictoIdentity PictoPuzzle there is almost no possibility of having a PictoIdentity be decoded by another.

Module C also allows a User to activate the controls to access the PictoCash Account using the PictoIdentity. The PictoOverlay Interface (POI) of Module C further provides links to PictoGames and mini-apps within the PictoCash Networks to make purchases, obtain minutes or upload or download software. Module C also provides synchronized data transfer to and from a local, internet or wireless server to support a User's transactions. The PictoCash Account, within Module C are also properly sized and formatted to display on a variety of electronic systems within a number of media platforms, such as personal computers, mobile devices, tablet computers and others. Module C also incorporates the requests to perform a transfer of intra-personal amounts between PictoCash Account Users to allow an exchange or refill of PictoCash dependent upon the Users establishing between themselves a method to repay or pay for such “borrowing”. A requested transfer code from the PictoCash Entity Management System may be emailed to another PictoCash Account User to complete the transfer of PictoCash funds as described herein.

The PictoOverlay Interface of Module C displays to the User all of the features for a User using the PictoIdentity to access the PictoCash Account through an internet connection. Using the PictoCash Account a User may review available PictoGames, mini-apps and other products within the PictoCash Network and make purchases, download PictoGames or other software, or perform other transactions. To complete a transaction such as downloading a software application, a user enters their unique PictoIdentity to complete the download. The PictoIdentity will transmit the adequate funds from the PictoCash Account to the PictoCash Entity Management System for payment for the software application. Importantly, if the PictoCash Account is depleted while downloading or playing a PictoGame or another software application, the PictoCash Software Application may stop the transaction and prevent the User from further access to the software application. The Entity Management System may then prompt the User to add PictoCash to the PictoCash Account and to re-enter their PictoIdentity to complete the transaction. Reward points or obtaining points through a PictoGame or other Competition may also be available to replenish the PictoCash Account. The PictoCash Account may be setup on a personal computer system, a mobile phone, smartphone, tablet computer, or other electronic device. Access to Help Information or to further review the Instructional Presentations may also be available using the Module C control features.

### Module C: PictoCash—Instructional Presentations

The User Application Software displays the Introduction Presentation to the User showing an overview of the features of a PictoCash Account. The Explanation Presentation is also provided to visually and succinctly give instructions on how to setup and use the PictoCash Account. The Navigator Presentation provides information on navigating through Montage Pages to access the advertised products of the PictoCash Network, or to navigate to download a PictoGame or other video game of application software, and how to navigate to other transactions. After the optional review of these presentations, the User is presented with a PictoCash Account Montage Page representing optional transactions using the PictoCash Account. These transactions may include for example, Open a New Account, Create a PictoIdentity, Check PictoCash Balance, Transfer Funds, Access Statements, Download Software, Receive Rewards, and Administrative Tools. Selecting a transaction opens another Montage Page with menu options that are related and required for the transaction. Control Buttons around the Montage Page may provide access to present additional Transaction Montage Pages or move back or forth through the displayed Montage Page.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the Components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### Some of the Objects of the Invention

An object of the invention is to provide a software platform on a computer system that creates an Enhanced Multi-Dimensional PictoCash Account and Network using dimensionally layered, displayable, Collage Images and Sequenced PictoStorys associated with a series of payment and account transactions for a User.

Another object of the invention is performing a secure payment or other transaction without providing personal identification information by using a unique PictoIdentity to validate the transaction.

Another object of the invention is the creation of a unique PictoIdentity that uses a series of chosen alphanumeric and static pictorial components and the dynamic presentation of a User Selected Identifiable Image within a PictoPuzzle to provide access to a secure, account, website, location, transaction or other secure areas.

Another object of the invention is the linking of a PictoCash Account and unique PictoIdentity to an electronic device thereby not requiring personal identification information, a password or login to be used to perform a payment or other financial transaction.

Another object of the invention is the development of the PictoCash Account and PictoCash Entity Management System using PictoStory Technology and the innovative Architectural Blueprint design work space to create, edit, modify and present the features and controls of the PictoCash Account.

Another object of the invention is use of the PictoOverlay Interface for formatting of the PictoCash Account on various media platforms such as mobile devices, personal computers and tablet computers to make all features usable and accessible to have a User make purchases, upload or download software or perform other transactions.

Another object of the invention is the creation of a series of dynamic, enhanced, overlaid visually ‘Show not Tell’ presentations using the PictoStory Technology to quickly and comprehensively show a User features, controls and navigation so that a User may immediately grasp the requirements to create and use a PictoCash Account.

Another object of the invention is the use of the Architectural Blueprint to develop a series of Transactional Pages to allow a User to perform payment transactions and software downloads.

Another object of the invention is the structure and formatting of an Architectural Blueprint with a Multilevel Reference Coordinate System and developing an encrypted file naming structure that reflects the Multilevel Reference Coordinate System to store and access PictoLayers formed from the Components and Sub-Components using the PictoLayer Generator.

Another object of the invention is to acquire and process one or more Components or Sub-Components, Raw Images or the Selected Identifiable Image using a PictoLayer Generator to shape, crop a portion of the Component, Sub-Component, Raw Image or the Selected Identifiable Image, size and locate the image on a transparent blank to form a PictoLayer that may be a Trans-Snip, Composite Image, PictoStory, Collage Image or other Component of the PictoIdentity or PictoCash Account.

Another object of the invention is to integrate audio, video, text, pictorial and non-pictorial Enhancements to the PictoLayers at any level such as to a Trans-Snip, a layered Composite Image, a group of layered Composite Images, a PictoStory, a Collage Image or at a presentation level to dynamically display the PictoIdentity PictoPuzzle and engage and inform the User about use of the PictoCash Account and available products on the PictoCash Network.

Another object of the invention is the categorization and indexing of Components and Sub-Components based on the PictoIdentity and PictoCash Account requirements and renaming and storing these PictoLayers using a PictoPuzzle Generator within a Data Store Resource.

Another object of the invention is using the renamed and stored PictoLayers to populate the Architectural Blueprint to create infinitely variable PictoIdentity PictoPuzzles for the User to indicate using a pointer device, keypad or touch screen their Selected Identifiable Image.

Another object of the invention is the seamless randomized replacement of Interchangeable PictoLayers within the PictoIdentity with Alternative PictoLayers using the Encrypted Coordinate File Naming System to prevent the same code from being shown to the User more than once further enhancing security.

Another object of the invention is the use of a Process Controller in the PictoCash Production Control Software to create, navigate, order, modify, enhance, edit, playback, review, combine, render, realize and activate the PictoIdentity and features of the PictoCash Account within the Architectural or PictoCash Blueprint.

A still further object of the invention is the accessing or downloading of one or more PictoGames or other software or purchasing of consumer products using the PictoIdentity and PictoCash Account.

A still further object of the invention is establishing and funding a PictoCash Account through a retail purchase and adding to the account with transfers or rewards from point scores or purchases within the PictoCash Network.

The present invention is related to an account management software system and apparatus, comprising application software installed on a computer system, the application software further comprising, a pictopuzzle generator, a pictolayer generator, a pictocomposite generator, an enhancements generator, an architectural blueprint, and a repository having points representing a monetary value; and wherein the points are accessible to perform a financial transaction by completing a pictoidentity. In the account management software system and apparatus, the completion of the pictoidentity comprises the identification of one of at least a letter, a number, a static picture, and a trans-snip dynamically presented in a pictopuzzle. The trans-snip is formed from a portion of an identifiable image and the pictopuzzle is formed from a plurality of pictolayers and the trans-snip using the pictopuzzle generator. Also in the account management software system and apparatus, the plurality of pictolayers are formed from one of at least a trans-snip, a composite image and a pictostory. The account management software system and apparatus further comprises a random generator for the selection of at least one alternative pictolayer to be used to replace at least one active pictolayer within the pictopuzzle. The at least one alternative pictolayer is renamed with a coordinate file name of at least one active pictolayer and the active pictolayer is replaced with the alternative pictolayer in the pictopuzzle.

In the account management software system and apparatus, the financial transaction is one of at least a download of a software application, a purchase of minutes for a mobile device, and a product purchase. The account management software system and apparatus further comprises one of at least an introduction presentation, an explanation presentation and a navigation presentation. The account management software system and apparatus further comprises an account associated with the repository and with an electronic device. The account management software system and apparatus also prevents the transmission of personal information associated with the user of the electronic device.

The present invention is also related to a method of securely authorizing a purchase transaction, comprising the steps of accessing application software installed on a computer system, creating a pictoidentity, comprising, choosing at least one alphanumeric value, choosing at least one static picture, selecting an image, creating a trans-snip from the image, creating a collage image that includes the trans-snip of the selected image and other trans-snips from a plurality of images, adding value points to a repository, and authorizing a purchase using the value points by completing the pictoidentity. The method of securely authorizing a purchase transaction further comprises the step of completing the pictoidentity by identifying at least one of the chosen alphanumeric value, the chosen static picture, and the trans-snip of the selected image from within a dynamic presentation of the collage image. The method of securely authorizing a purchase transaction further comprises the step of replacing at least one of the other trans-snips from the plurality of images in the dynamically presented collage image.

The method of securely authorizing a purchase transaction further comprises the step of completing the pictoidentity by using a keypad of a small cellular telephone or by using a touchscreen. The method of securely authorizing a purchase transaction also further comprises the step of associating an account for the repository with an electronic device and preventing the electronic transmission of personal information associated with the user of the electronic device. The method of securely authorizing a purchase transaction also further comprises the step of accessing the account using only the pictoidentity.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating a first embodiment of the Modules A, B, and C that in a first embodiment make up the Enhanced Multi-Dimensional PictoCash Application Software of the present invention;

FIG. 2 is a block diagram of a first embodiment of the Components and Sub-Components that are used to create PictoLayers in an embodiment of the PictoCash Application Software;

FIG. 3 is a block diagram of a first embodiment of the PictoCash Network in an embodiment of the present invention;

FIG. 4 is a diagrammatic representation of an Alphanumeric Block that may be chosen within the PictoIdentity in an embodiment of the present invention;

FIG. 5 is a first embodiment of a Major Theme Montage Page with one or more pictures that are chosen for the PictoIdentity in an embodiment of the present invention;

FIG. 6 is a first embodiment of a Sub-Theme Montage Page with one or more pictures that are chosen for the PictoIdentity in an embodiment of the present invention;

FIG. 7 is a first embodiment of a Sub-Topic Montage Page with one or more pictures that are chosen for the PictoIdentity in an embodiment of the present invention;

FIG. 8 is a first embodiment of a selected image for a PictoIdentity in an embodiment of the present invention;

FIG. 9 is illustrative representation of a first embodiment of a PictoIdentity PictoStory Page within an Architectural Blueprint Referenced Page Cell Map in an embodiment of the present invention;

FIG. 10 is a first embodiment of the formation of a Trans-Snip from the selected image in an embodiment of the present invention;

FIGS. 11A-11C are a diagrammatic representation of the formation of a Trans-Snip from the selected image in an embodiment of the present invention;

FIG. 12 is a diagrammatic representation of a selection of images for a PictoIdentity PictoPuzzle using the PictoPuzzle Generator in an embodiment of the present invention;

FIGS. 13A-13F are diagrammatic representations of the formation of a Collage Image for the PictoIdentity PictoPuzzle in an embodiment of the present invention;

FIGS. 14A-14B are diagrammatic representations of further embodiment of the formation of a Collage Image for the PictoIdentity PictoPuzzle in an embodiment of the present invention;

FIGS. 15A-15C are diagrammatic representations of still further embodiment of the formation of a Collage Image for the PictoIdentity PictoPuzzle with an alternative PictoLayer in an embodiment of the present invention;

FIG. 16 is a diagrammatic representation of the construction in Module A of a PictoIdentity PictoPuzzle with a Trans-Snip of the selected image in an embodiment of the present invention;

FIG. 17 is a block diagram of a first embodiment of the computer platform of the Enhanced Multi-Dimensional PictoCash Application Software of the present invention;

FIG. 18 is a diagrammatic representation of a first embodiment of a PictoCash Account PictoStory Page within the Architectural Blueprint in an embodiment of the present invention;

FIG. 19 is a diagrammatic representation of a first embodiment of a PictoCash Account Software Referenced Page Map in an embodiment of the present invention;

FIG. 20 is a diagrammatic of a first embodiment of the Production Presenter of Module C in an embodiment of the present invention; and

FIG. 21 is an illustrative representation of a first embodiment of the PictoOverlay Technology that dynamically presents a PictoIdentity PictoPuzzle in an embodiment of the present invention.

### DETAILED DESCRIPTION OF THE INVENTION

Turning now descriptively to the drawings, in which similar reference characters denote similar elements throughout the several views, the figures illustrate the Enhanced Multi-Dimensional PictoCash Application Software that uses Collage Images formed from a series of Enhanced Sequenced PictoStorys that create a secure access PictoIdentity and establish a PictoCash Account with features and controls to perform transactions, make purchases and download software on personal computers, mobile devices, tablet computers, electronic devices, and other computer and electronic systems.

### Details of the Enhanced Multi-Dimensional PictoCash Software Modules

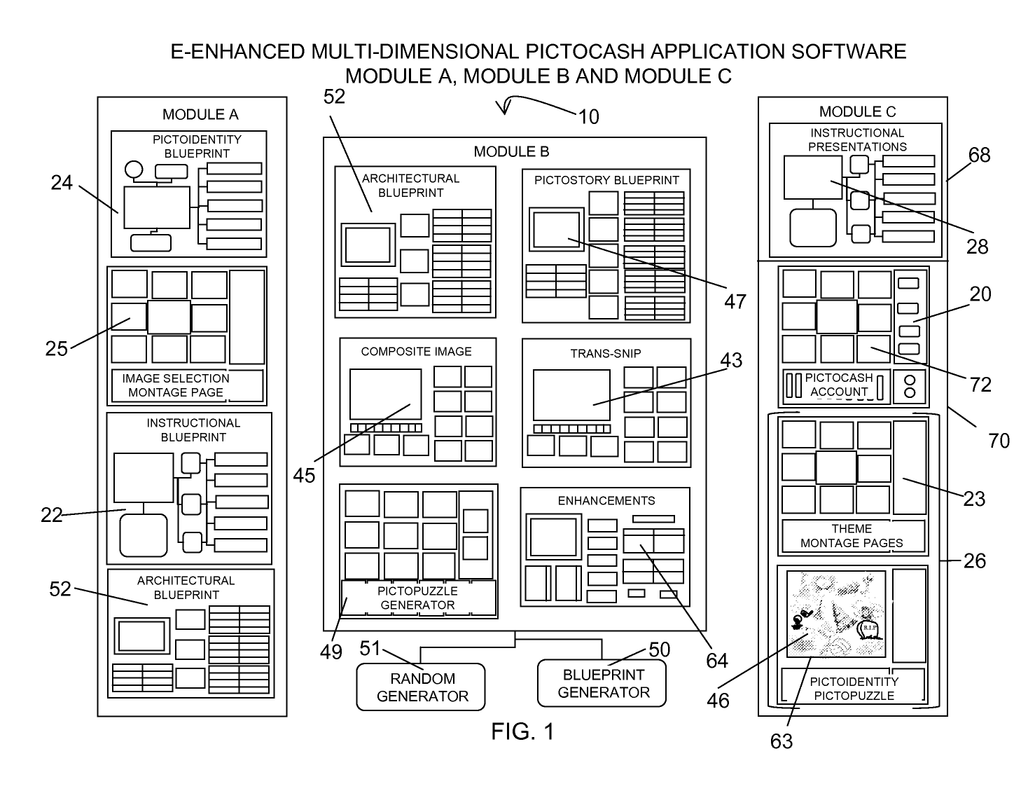

As shown in FIG. 1, the Enhanced Multi-Dimensional PictoCash Software Application 10 is comprised of three Modules, A, B and C that develop, populate, and present the PictoCash Account 20 and the features of the PictoCash Network 30. Module A includes the structure and formatting of the PictoIdentity 26 of the Theme Montage Pages 23 and Image Selection Page 25 within the PictoIdentity Blueprint 24. Module A also includes an Instructional Blueprint 22 that creates the series of Introduction, Explanation and Navigation Presentations 28 to inform and instruct the User on the PictoCash Account 20 features. The Presentations 28 display how to create a PictoIdentity 26, how to initiate and fund the PictoCash Account 20, how to access the PictoCash Network 30 and how to access controls to use other features of the PictoCash Account 20. Module A also develops the format and structure of a Blank Architectural Blueprint 52 that using the Blueprint Generator 50 of Module B to create the features of the PictoCash Account 20.

Module B includes the formatted and structured PictoCash Architectural Blueprint 52 that provides the work space to implement the features of the PictoCash Application Software using the PictoOverlay Technology and a number of Sequenced PictoStorys 34. Module B also includes the Production Populator 36 for Populating the Blueprint 52 with the Composite Image Pages 45 and Trans-Snip Pages 43 that form the series of Sequenced PictoStorys 34 that are developed in the PictoStory Blueprint 47. A Process Controller 38 in Module B is also available to create, navigate, order, modify, enhance, edit, playback, review, combine, render, realize and activate the PictoStorys 34 to display the features of the PictoCash Account 20. Module B also includes the Enhancements Generator 62 that develops Enhancements 64 that may be associated with the PictoLayers 44 of the PictoCash Account 20. Also importantly, using a PictoPuzzle Generator 49, PictoLayers 44 of Trans-Snips 33 and Composite Images 35 are selected for the PictoIdentity PictoPuzzle 63. These PictoLayers 44 are randomly selected using the Random Generator 51 to create a unique Collage Image 42 that includes the User's Selected Identifiable Image Trans-Snip 46.

Module C includes the Production Presenters 68 that present the Introduction, Explanation, and Navigator Instructional Presentations 28 to succinctly and comprehensively show a User how to setup and use the PictoCash Account 20. Module C also includes the PictoOverlay Interface 70 that presents the PictoCash Account 20 features and controls for a User to navigate through the Transaction Montage Page 72 to access mini-apps, PictoGames and consumer products from Authorized Dealers within the PictoCash Network 30 and purchase products, obtain cell phone minutes and upload or download the software applications. The PictoOverlay Interface 70 also dynamically presents the Theme Montage Pages 23 that include the Alphanumeric Montage Page, the Major Theme, Sub-Theme and Sub-Topic Montage Pages and the PictoIdentity PictoPuzzle 63 that together for the PictoIdentity 26 that must be completed to validate any transaction within the PictoCash Network 30.

### Details of Module A: The Intro-Explain-Navigate Generator

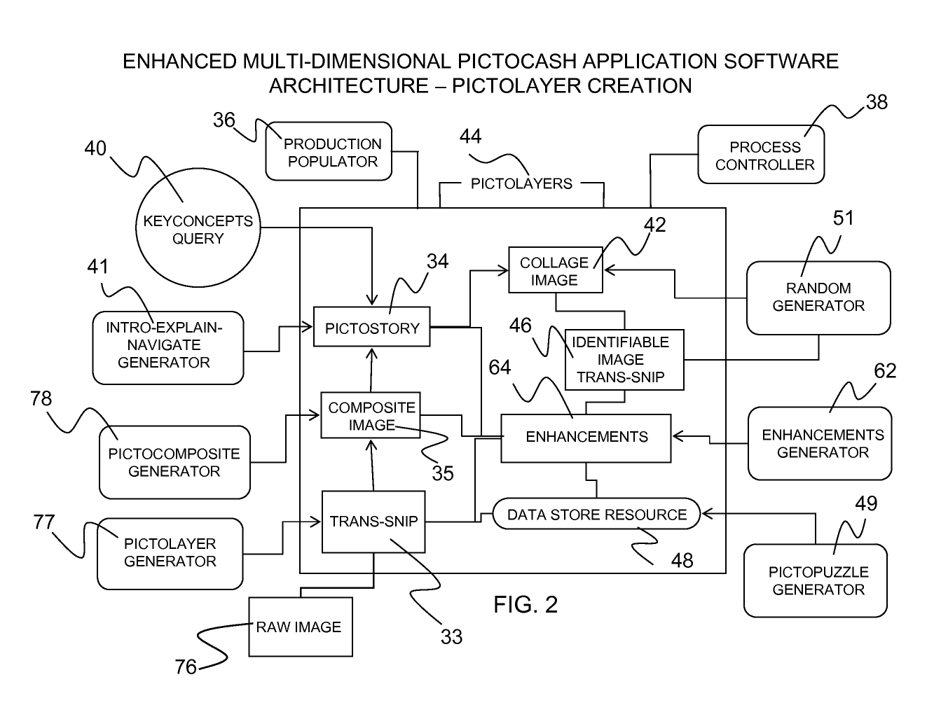

A series of PictoCash Account Presentations 28 are developed using the Intro-Explain-Navigate Generator 41 that creates the Instructional Blueprint Page 22 and develops the set of pictorial instructional presentations that clearly convey the unique features of the PictoCash Account 20 and creation of the PictoIdentity 26. The Presentations 28 are constructed from a series of Enhanced Sequenced PictoStorys 34 that are formed from layered Composite Images 35 as shown in FIG. 2. The PictoStorys 34 are derived from information obtained by applying a KeyConcepts Query 40 and structuring a series of images to the answers to the Query 40 to display a Show not Tell Presentation to explain the features and benefits of the PictoCash Account 20. In creating a Presentation 28, the PictoStorys may be associated with one or more Enhancements 64 to order and present the PictoStorys 34 sequentially in the film-like Instructional Presentations 28. Each of the Introduction, Explanation and Navigation Presentations are similarly created using the Intro-Explain-Navigate Generator 41 and are developed within the Instructional Blueprint Page 22.

Within the Architectural Blueprint 52, a Referenced Page Cell Map 202 provides a grid-like coordinate system to locate the PictoLayers 44 that comprise the PictoStorys 34 and their Components and Sub-Components within any of the Blueprint Pages that make up the Instructional Presentations 28 and other features of the PictoCash Account 20. A Referenced Page Map 204 provides a navigator to access all of the PictoLayers 44 and Components and Sub-Components of the Presentations 28 and of other features within the PictoCash Account 20. The Process Controller 38 and Enhancements Generator 62 provide a group of controls to add audio and video effects to view the Sequenced PictoStorys 34 within the Presentations 28. The Instructional Blueprint Page 22 is structured with a location and coordinate file corresponding to a position within the Referenced Page Map 204 of the Architectural Blueprint 52. The Active Components of the Presentations 28 are located and renamed with associated coordinate positions within the Referenced Page Map 204 and are stored in the Output Folder of the Data Store Resource 48.

As an example, the Introduction Presentation may show a rapid synopsis of accessing the PictoCash Account 20 using the PictoIdentity 26 and the Explanation Presentation may show how to use each of the features of the PictoCash Account 20 to perform a transaction such as by pictorially showing a pointer device or mouse selecting each PictoCash Account 30 control and demonstrating the function. The Navigation Presentation may succinctly present linking to a Commercial Entity within the PictoCash Network 30 using the Transaction Montage Page 72.

### Details of the PictoCash Network

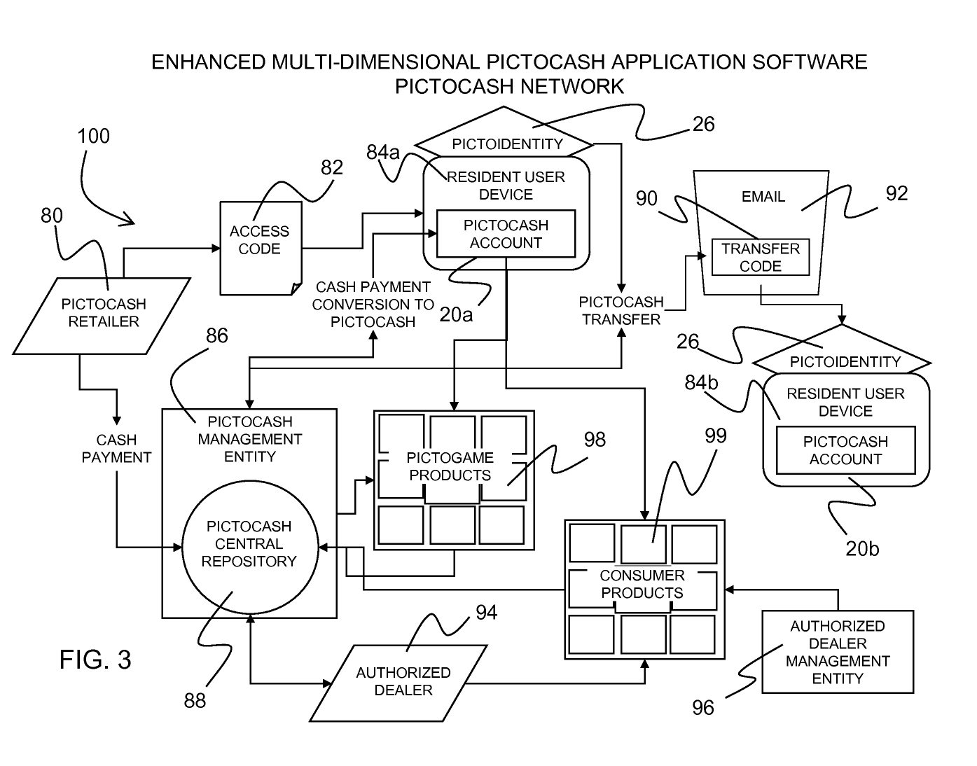

In a first embodiment, an account may initially be setup through a retail store purchase of an Access Code 82 printed on a receipt from a PictoCash Authorized Retailer 80 as shown in FIG. 3. As an example, the Access Code 82 may be a 12 digit number that the User enters to open the PictoCash Application Software 10 through a local area network LAN or wireless internet connection on a resident user device 84 such as a computer, a laptop, an iPod, an iPad, a tablet computer, a smartphone or other electronic device. Importantly, the Access Code 82 does not include any of the User's personal information, or any association with the User's particular PictoCash Account 20. The Access Code 82 simply provides access to the PictoCash Software Application 10 to setup or replenish a PictoCash Account 20. Therefore, because the Access Code 82 is not associated with any personal information, the Access Code 82 if stolen would allow another User to enter the code and receive the converted PictoCash if they entered the Access Code 82 prior to the User who made the purchase. Once entered and validated by the PictoCash Management Entity 86, the PictoCash conversion and deposit is made into whichever PictoCash Account 20 a completed PictoIdentity 26 is associated with regardless if the PictoCash Account is the account of the User that made the initial retail purchase. The Access Code 82 is then invalid and blocked from reentry.

At the time of purchase as shown in FIG. 3, the cash payment minus any transaction fees is stored in a PictoCash Central Repository 88 of the PictoCash Management Entity 86 and when the Access Code is entered and validated the cash payment is converted to PictoCash and deposited in the PictoCash Account 20 associated with the completed PictoIdentity 26 of the Resident User Device 84. The PictoCash represents points or minutes or credit for the purchased cash payment that may be used to establish a starting balance or replenish a PictoCash Account 20. As described above, upon entering the software application a blank Architectural Blueprint 52 is structured and formatted in Module A for the creation of a PictoCash Account 20 on a specific Resident User Device 84. The Architectural Blueprint 52 is populated with a series of PictoStorys 34 that are created using a series of KeyConcept Querys 40 to develop the features of the PictoCash Account 20.

PictoCash funds may be transferred from one PictoCash Account 20a to another PictoCash Account 20b by requesting a Transfer Code 90 from the PictoCash Management Entity 86. The User then enters their PictoIdentity 26 to verify the transaction and the PictoCash Software 10 generates a twelve digit code similar to the Access Code 82 that may be entered on a second Resident User Device 84b. An Email 92 may also be sent to another User for them to enter the Transfer Code 90 into another PictoCash Account 20b. Upon request of a Transfer Code 90 the PictoCash funds are immediately transferred from the first PictoCash Account 20a to the PictoCash Central Repository 88 where they are held until the Transfer Code 90 is entered for the receiving PictoCash Account 20b. In this way, a balance cannot be overdrawn on a PictoCash Account 20, by requesting additional funds that are unavailable while a transfer is pending. Upon the transfer request the funds are immediately moved to the PictoCash Central Repository 88 and are therefore unavailable for another transaction. Upon entering the Transfer Code 90, the transaction is validated by having the User of the second PictoCash Account 20b complete their unique PictoIdentity to securely transfer the funds from the PictoCash Central Repository to the second PictoCash Account 20b.

Transactions within the PictoCash Network 100 may be performed to purchase PictoGames 98 and other software and mini-apps offered by the PictoCash Management Entity 86 within the PictoCash Network 100. An Authorized Dealer 94 may also provide other music, software or other External Consumer Products 99. PictoCash is used for these purchases with transactions performed between the PictoCash Management Entity 86 and the Authorized Dealer Management Entity 96 to accept and validate a transaction request from a User and transfer funds from the PictoCash Central Repository 88 to the Authorized Dealer 94.

### Details of Module A: Creating the PictoIdentity

The present invention uses a completely unique approach to develop a security platform to perform a financial transaction without requiring a user to enter any personal information. The transaction may be completed on a mobile device, a computer, or other media platform. The unique security platform referred to herein as the PictoIdentity 26 may further be used to unlock a door, open a safe or gain access to another device or location. In the initial setup of a PictoCash Account 20, the User must first create a PictoIdentity 26 which the User must complete to verify and perform any transaction within the PictoCash Network 100. Importantly, in completing the PictoIdentity 26 the User does not enter any personal contact or financial information and there is absolutely no contact or financial information associated with any PictoCash Account 20 or stored and associated with the PictoCash Account 20 by the PictoCash Management Entity 86. The creation of a PictoIdentity 26 involves three steps with the User making personal choices to develop a PictoIdentity 26 that is completely unique to them.

### Details of Module A: The PictoIdentity Alphanumeric Block

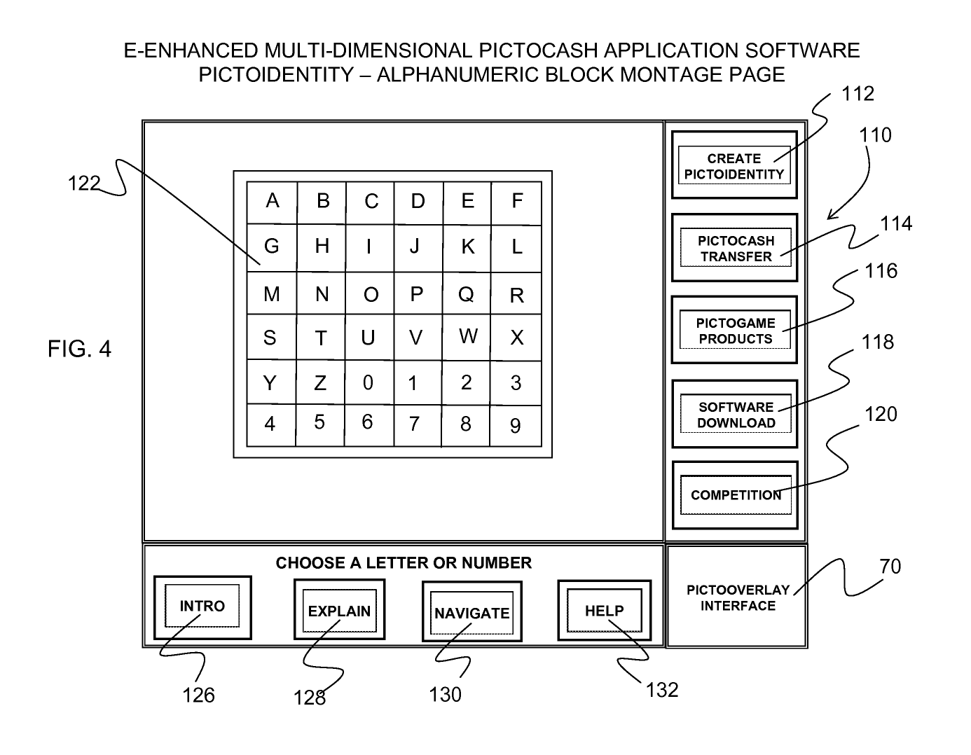

As shown in FIG. 4, in a first step, an Alphanumeric Block Montage Page 110 is created in Module A for the User to choose a letter or number to initiate the PictoIdentity 26. The choice of a letter and/or number from the Alphanumeric Block is an optional step in an embodiment of the PictoIdentity. In further embodiments, the User may begin the PictoIdentity with the choice of a Major Theme, not a letter or number. In a first embodiment, the Montage Page 110 presents the twenty-six letters of the English Alphabet and the numbers 0-9. Importantly, each Montage Page developed in Module A is formed from a layered Composite Image 33 made up of a series of Trans-Snips 34 in a 6×6 configuration that is formatted to be easily viewable on even the smallest cellular phone display or any mobile device that provides for User to easily choose an option from the Montage Page using a keypad, mouse touch screen or other pointer device. A chosen letter or number is indicated in the Alphanumeric Block 122 and becomes part of the User's unique PictoIdentity 26.

The PictoOverlay Interface 70 may display options for the User to perform transactions such as an option to Create a PictoIdentity 112, to request a Transfer of PictoCash 114 from the PictoCash Account 20, to view PictoGame Products 116 and other products within the PictoCash Network 100, to perform a Software Download 118, to enter a Competition 120 or perform other options. The PictoOverlay Interface 70 may further provide access to view the Introduction 126, the Explanation 128, or Navigation 130 Instructional Presentations or a Help 132.

### Details of Module A: The PictoIdentity Theme Montage Pages

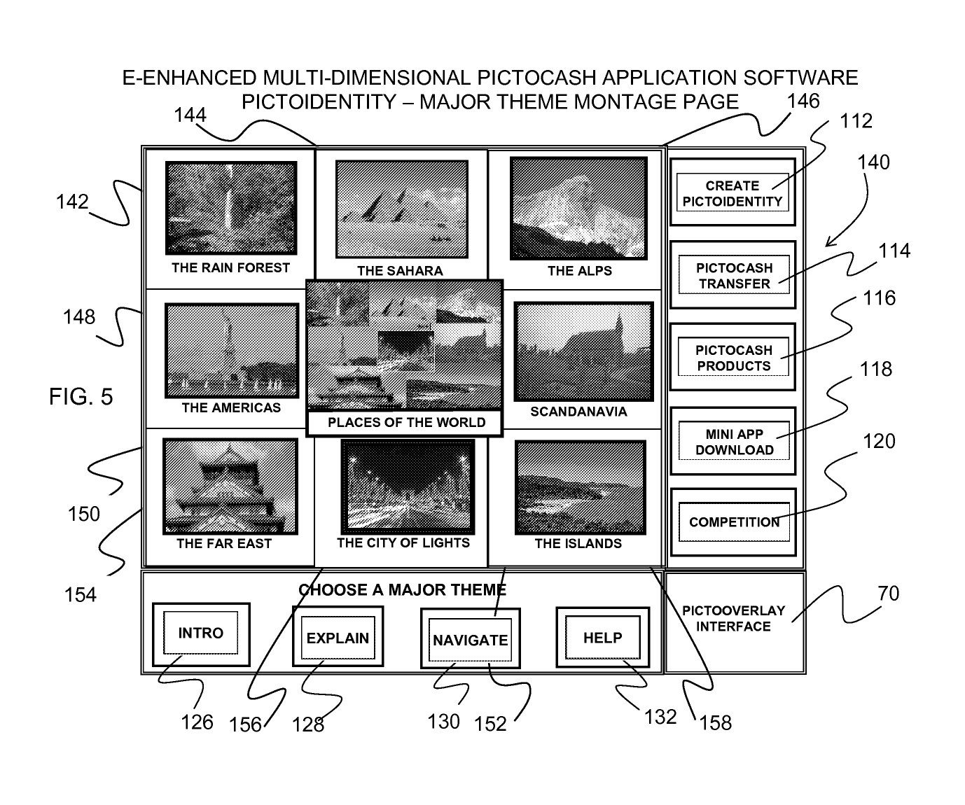

The Major Theme, Sub-Theme and Sub-Topic Montage Pages 23 are developed in Module A with a set of eight labeled pictures in a 3×3 format surrounding a center picture that is labeled as the general Theme of the Montage Page. The Theme Montage Pages 23 may be the same static pictures for all Users with each picture remaining in a static location within the Montage Page or in a randomized location with each picture interchanged around the central general them picture. In a first example as shown in FIG. 5, the general Major Theme Montage Page 140 may be Places of the World indicated in the center picture 150. The surrounding labeled pictures may display geographic locations around the globe where in this example the pictures shown are The Rain Forest 142, The Sahara 144, the Alps 146, the Americas 148, Scandinavia 152, the Far East 154, The City of Lights 156 and the Islands 158.

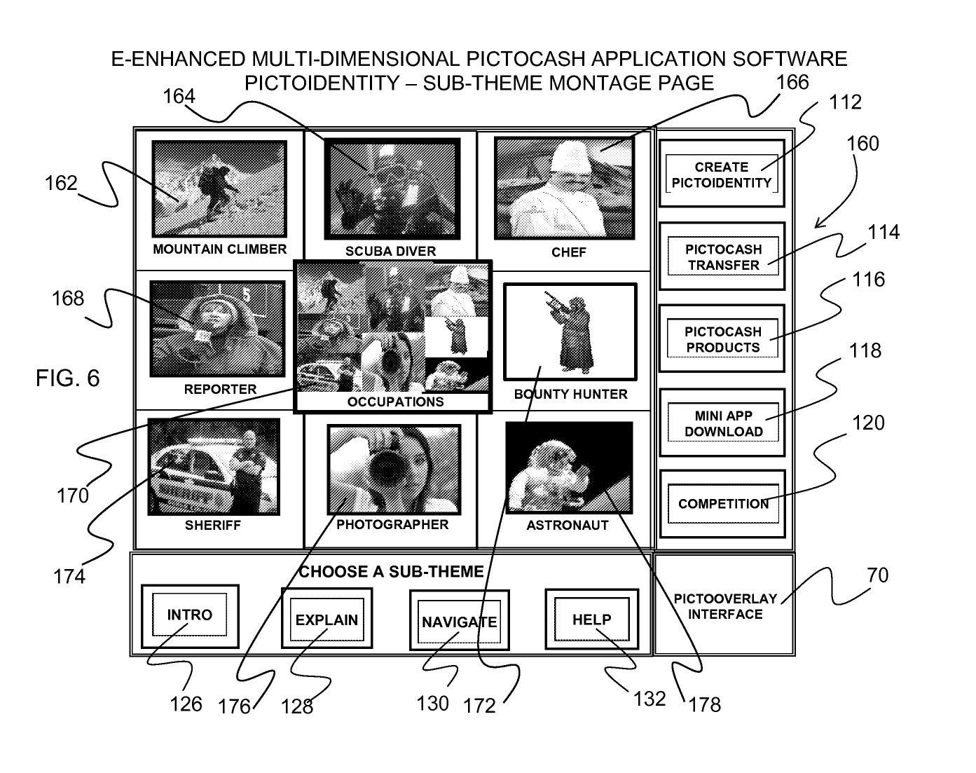

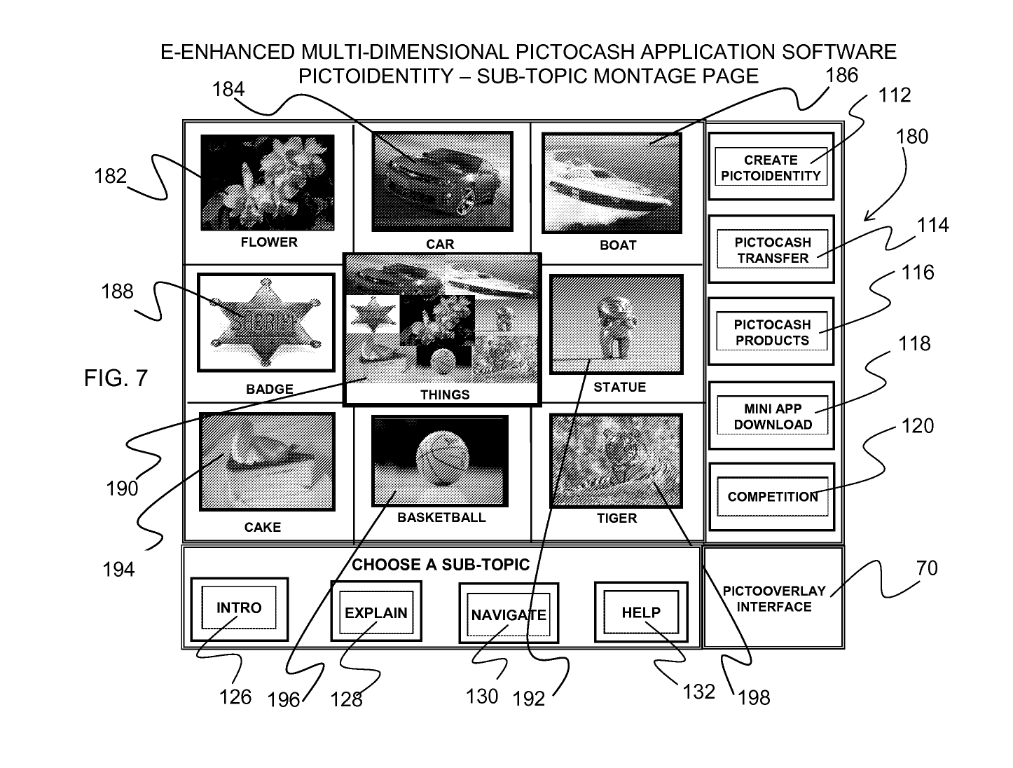

An example of a Sub-Theme Montage Page 160 is shown in FIG. 6 with the Sub-Theme representing Occupations 170. In this example the pictures shown display a Mountain Climber 162, a Scuba Diver 164, a Chef 166, a Reporter 168, a Bounty Hunter 172, a Sheriff 174, a Photographer 176 and a Astronaut 178. An example of a Sub-Topic Montage Page 180 is shown in FIG. 7 with the Sub-Topic representing Things 190. In this example the pictures shown display a Flower 182, a Car 184, a Boat 186, a Badge 188, a Statue 192, a piece of Cake 194, a Basketball 196 and a Tiger 198. The pictures of the Major Theme Montage Page 140, the Sub-Theme Montage Page 160 and the Sub-Topic Montage Page 180 may be related in some way, such as the Americas 148, a Sheriff 174 and a Badge 188 or may have no relationship, and the User is free to choose any Major Theme picture, any Sub-Theme or any Sub-Topic. In further embodiments, any number of letters and numbers and Theme pictures may be chosen to create the PictoIdentity 26 with each choice further extending the complexity of the PictoIdentity 26. To complete the choice of a letter or number from the Alphanumeric Block 122 and chosen pictures from Theme Montage Pages 23, the User must select the Create PictoIdentity Option 112 as an example after each choice to lock each choice in as parts of the PictoIdentity 26.

Importantly, the Alphanumeric Block 122 and the other Theme Montage Pages 23 of the PictoIdentity 26 are located within the Architectural Blueprint 52 therefore include a Referenced Page Cell Map 202 and a Referenced Page Map 204. The Architectural Blueprint 52, within the PictoCash Application Software is never shown to the User. However, in this manner, the actual choice by a User is designated as a location and encrypted, meaning that the actual letter, number value or chosen picture is never communicated to the PictoCash Management Entity 86 but instead an encrypted code representing the coordinates of the choices for the PictoIdentity 26 are transmitted, further preventing a hacker from determining the choices made for the PictoIdentity 26. The Alphanumeric Block 122 and the pictures of Theme Montage Pages 23 may further be presented in a randomized manner, so the User's chosen picture is still within the eight options around the center picture, but is not in the same location. A User must review and choose the correct picture for their unique PictoIdentity 26 further preventing a prying eye or hacker from determining the unique PictoIdentity 26.

### Details of Module A: The PictoCash PictoPuzzle Generator

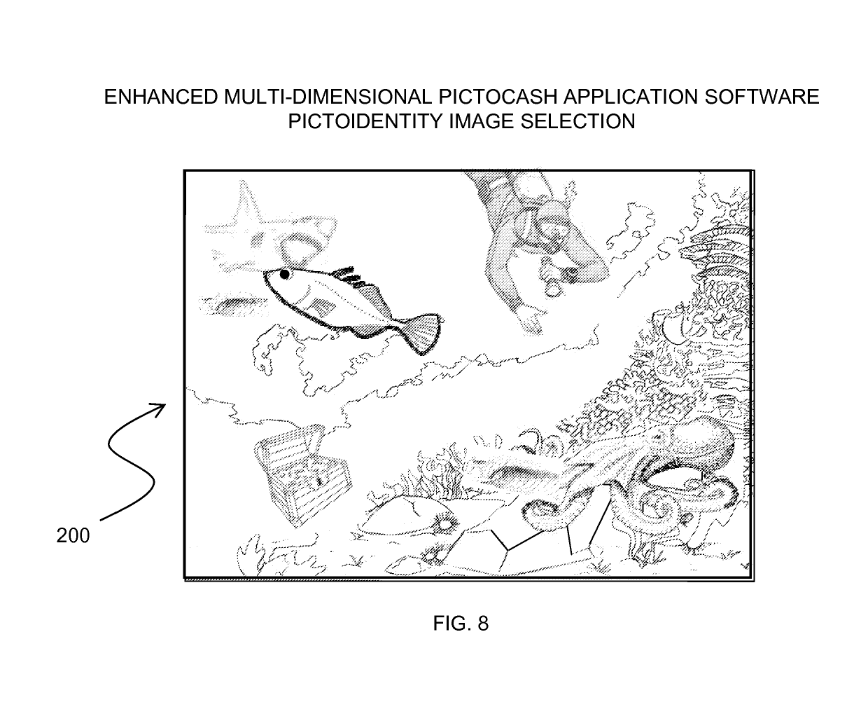

The Alphanumeric Block 122 and the Theme Montage Pages 23 are developed in Module A for the User to make choices to complete the first and second steps in the creation of the User's unique PictoIdentity 26. The final step in the creation is the selection by a User of an Identifiable Image 200 as shown in FIG. 8. The Identifiable Image 200 may be selected by the User from a series of images presented in one or more Image Selection Montage Pages 25 that are created by the PictoCash Application Software 10 using the PictoPuzzle Generator 49. The PictoPuzzle Generator 49 categorizes and indexes tens of thousands of Raw Image files 81 within the Data Store Resource 48 and assembles the Montage Pages 25. The Image Selection Montage Page 25 may be related to a theme or topic and display a series of images related to that topic or the Montage Page 25 may be formed from a series of unrelated images. The User scans each image from the Montage Page 25 and selects the identifiable image that will be used in their PictoIdentity 26 or selects an option button to display another Image Selection Montage Page 25 to select from.

The image files that are presented within the Image Selection Montage Page 25 are selected by the PictoPuzzle Generator 49 and are renamed using the encrypted Coordinate File Naming System based on the formatted Location Coordinate structure of the Architectural Blueprint 52. The Coordinate File Naming Structure and PictoPuzzle Generator 50 provide an index so that files of similar Components and of similar subject matter are named similarly, so that a group of related images or completely random images may be presented. These structured or randomly selected images are stored in the Data Store Resource 48 in a Variable Output Folder. Upon the option by the User to display another Image Selection Montage Page 25, a series of images from the Variable Output Folder are renamed with the Coordinate File Naming Structure of the Image Selection Montage Page 25 and are copied into an Active Folder in the Data Store Resource to be viewed within the Montage Page 25 by the User The User may select any number of Identifiable Images 200 to be used in the PictoIdentity 26, although preferably in a first embodiment a single Identifiable Image 200 is selected.

### Details of Module A: Structuring the PictoIdentity Architectural Blueprint

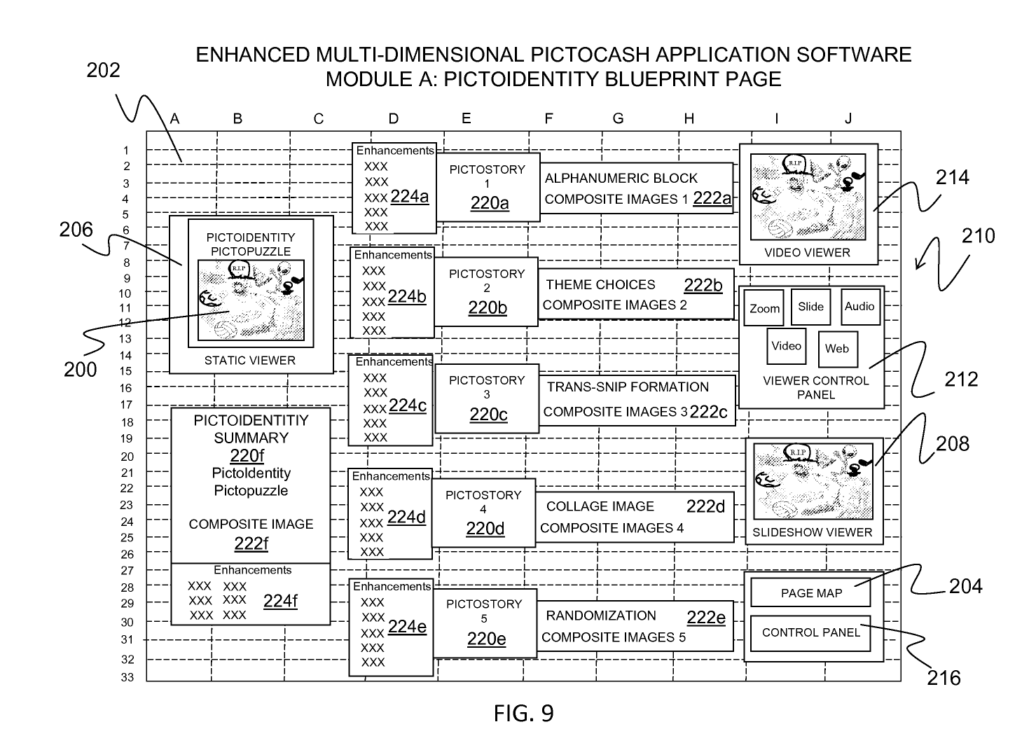

The Architectural Blueprint 52 is structured and formatted within Module A and populated with the Alphanumeric Block 122 and Theme Montage Pages 23 in Module B. As shown in FIG. 9, the chosen letter or number and chosen Major Theme, Sub-Theme and Sub-Topic pictures and the Selected Identifiable Image 200 are all located within the Architectural Blueprint 52 to form the PictoIdentity Page 210, as shown in FIG. 9. The PictoIdentity Page 210 includes a series of Sequenced PictoStorys 220a-220e that are made up of the series of PictoLayers 44 that form the PictoIdentity 26. The PictoStorys 222 include the letter or number chosen in the Alphanumeric Block 222a, the pictures chosen from the Theme Montage Pages 222b, and the Trans-Snip formation of the Selected Identifiable Image 222c, the formation of the Collage Image for the PictoIdentity PictoPuzzle 222d and the randomization of the PictoLayers within the PictoIdentity PictoPuzzle 222e as described herein. Each PictoStory 222 may be accessed and modified using the Process Controller 38 and other Production Control Tools within the Blueprint Generator 50 of Module B.

The PictoStorys 222a-222e are also transformed using Enhancements 224a-224e to present the PictoStorys 222a-222e sequentially or in any desired order to display the PictoIdentity 26 as an Interactive Multi-Dimensional Film-Like Presentation. The PictoStorys 222a-222e are located on the Reference Page Cell Map 202 for the PictoIdentity Page 210 within the Architectural Blueprint 52. The PictoIdentity Page 210 also provides three viewers to review and edit the presentation of the PictoStorys 222a-222e; the Static Control Viewer 206, the Slide Show Viewer 208 and a Video Viewer 224. The Selected Identifiable Image 200 is shown statically and enlarged in the Control Viewer 206 for review and editing of its PictoLayers 44 and a PictoIdentity Summary 220f may be provided with a compilation of the Composite Images 222f and Enhancements 224f associated with the PictoIdentity Page 210. The PictoIdentity Page 210 includes access to the Referenced Page Map 204 to navigate to the Components and Sub-Components of the PictoStorys 220a-220f located within the PictoIdentity Page 210 and to other Components within the Architectural Blueprint 52. A Control Panel 216 with tools to edit features within the PictoIdentity Page 210 is also included. The PictoIdentity Page 210 also includes Video Control Tools 212 to activate and render the PictoIdentity 26 for viewing in the Module C Production Presenter 68.

### Details of Module A: PictoIdentity Trans-Snip Formation

The PictoIdentity Page 210 includes the formation of a Trans-Snip 33 from the Selected Identifiable Image 200 to be used in a PictoIdentity PictoPuzzle 63. From the Selected Identifiable Image 200 a series of Trans-Snips 33 may be formed to use randomly so that the same Trans-Snip 33 is never presented twice within a PictoIdentity PictoPuzzle 63. The Trans-Snip 33 presents only a portion of the Selected Identifiable Image 200 and therefore the User must identify the Trans-Snip 33 that represents only a portion of the Identifiable Image 200 as described herein providing for increased security, where the Trans-Snip Image 46 is not simply for example a red sports car, but is instead only a portion of the Selected Identifiable Image 200 of the red sports car that is known only to the User.

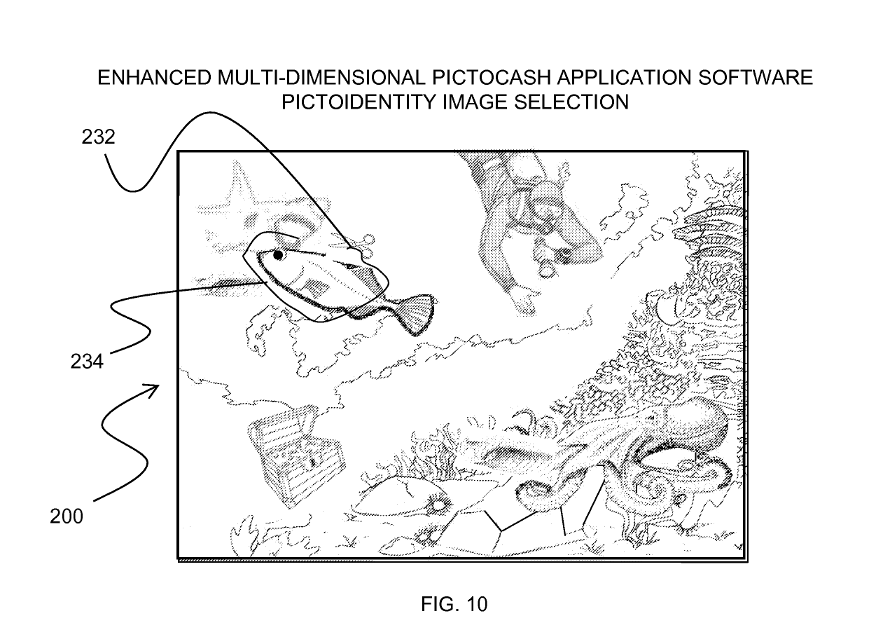

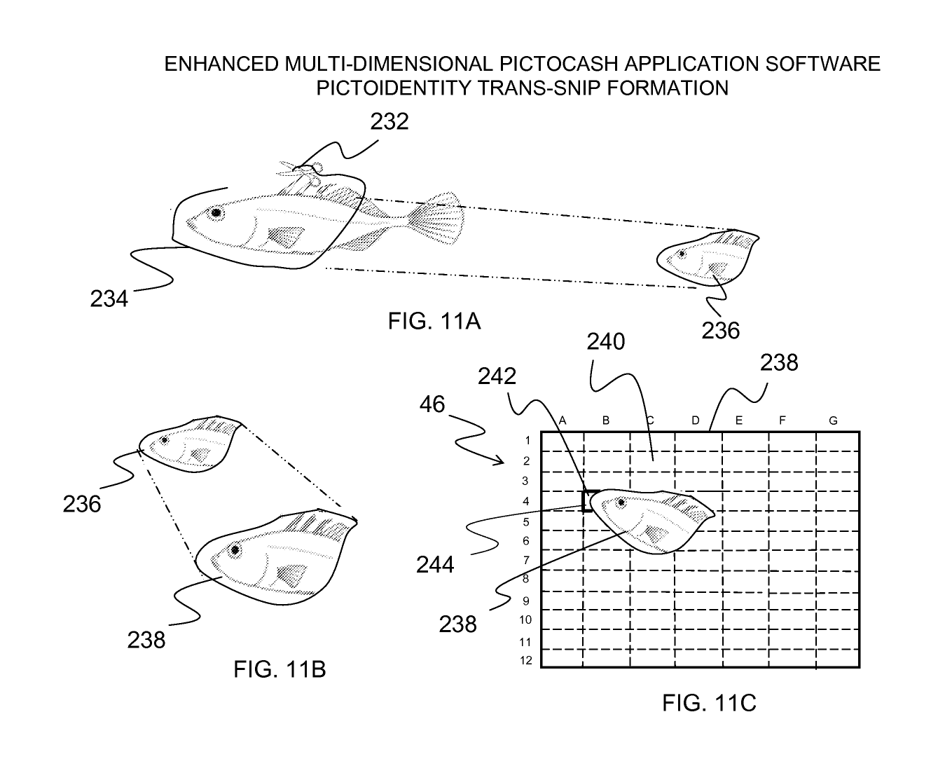

In forming a Trans-Snip 33, the Selected Identifiable Image 200 is located within the PictoIdentity Page 210 of the Architectural Blueprint 52. As shown in FIG. 10, using the PictoLayer Generator 77, a cutting tool 232 allows for a portion of the image 200 to be traced and cut out. The Trans-Snip cutout 234 may be shape cropped into any shape by moving the cutting tool 232 over any portion of the Selected Identifiable Image 200 or by selecting a preset shape such as an oval or rectangle using the PictoLayer Generator 77. In this example as shown in FIGS. 11A-11C, the Selected Identifiable Image 200 is an underwater scene with a portion of a outlined and cut out around the head and fin forming a partial image 236 of the fish. The shape cropped image 236 is resized to any desired dimension within the horizontal and vertical limits of a Transparent Blank 238. In this example, the partial fish cut out 236 is enlarged and the white background around the image is removed indicated as 238. A white background is commonly created using a variety of snipping software tools for cropping an image. An exclusive feature of the PictoLayer Generator 77 is the removal of this white border providing for the Trans-Snips 33 to form a layered Decoupage. The Transparent Blank 238 includes a Referenced Resolution Cell Map 240 and the partial fish image 238 is located on the Cell Map 240. The image 238 may further be oriented in any direction and be given a cell reference location by aligning for example its furthest left highest point 242 to indicate in this example, the coordinate position of B4 indicated as 244 within the Resolution Cell Map 240. The resized, shaped cropped image selected by the User with the white background removed and located at a reference coordinate on the Transparent Resolution Cell Map 240 forms the Selected Identifiable Image Trans-Snip 46 as shown in FIG. 11C.

The Process Steps, Components and Sub-Components of Selected Identifiable Image Trans-Snip 46 are located within the Architectural Blueprint 52 as a Trans-Snip Page with each process step displayed including the shaping, the cropping, the sizing, the removal of the white background and the locating of the image on the Resolution Cell Map 240. The Trans-Snip 46 may be associated with one or more Enhancements 64 and these are also displayed and accessible within the Trans-Snip Page. The Process Steps, Components and Sub-Components of the Selected Identifiable Image Trans-Snip 46 are all PictoLayers 44 and are accessible using the Referenced Page Map 204 of the Architectural Blueprint 52.

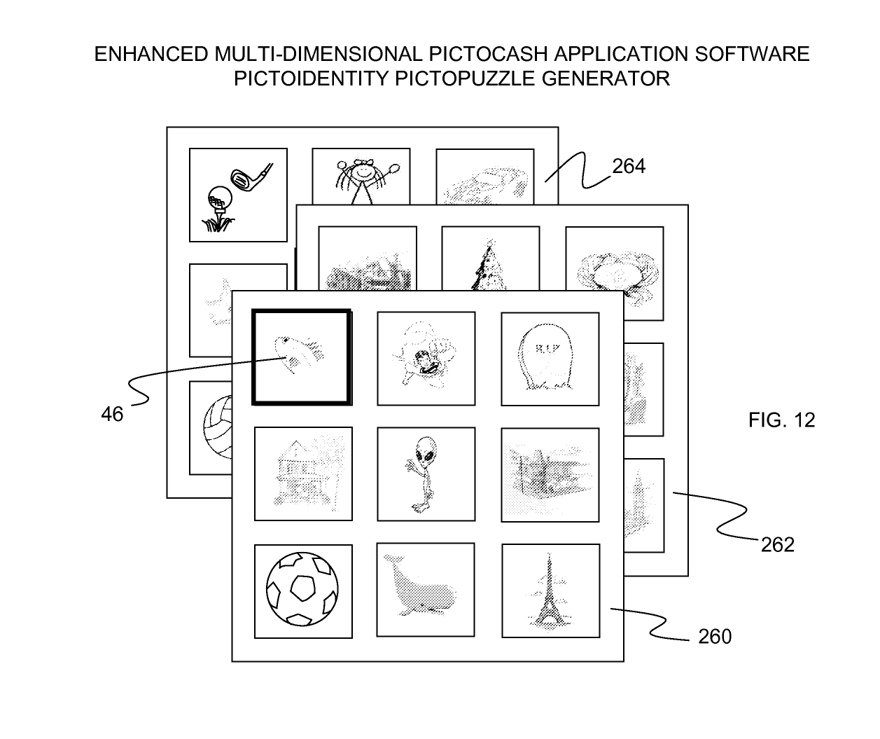

As shown in FIG. 12, a series of Trans-Snips 33 are formed from randomly selected Raw Images 76 using the PictoLayer Generator 77 and are in this example, presented in a series of Montage Pages 260, 262 and 264. The Trans-Snips 33 are stored within the Variable Output Folder in the Data Store Resource 48. The PictoCash Software Application 10 may form any number of Image Trans-Snips 63 to be used in the Collage Image 42 for the PictoIdentity PictoPuzzle 63 and thereby continually randomize the Trans-Snips 33 that are presented to the User so that the User must carefully review the PictoPuzzle 63 to identify their Selected Identifiable Image Trans-Snip 46. As an example, between twelve and forty-eight Trans-Snips 33 may be created using the PictoLayer Generator 77 to be displayed in the PictoIdentity PictoPuzzle 63.

### Details of Module A: Formation of the PictoIdentity PictoPuzzle

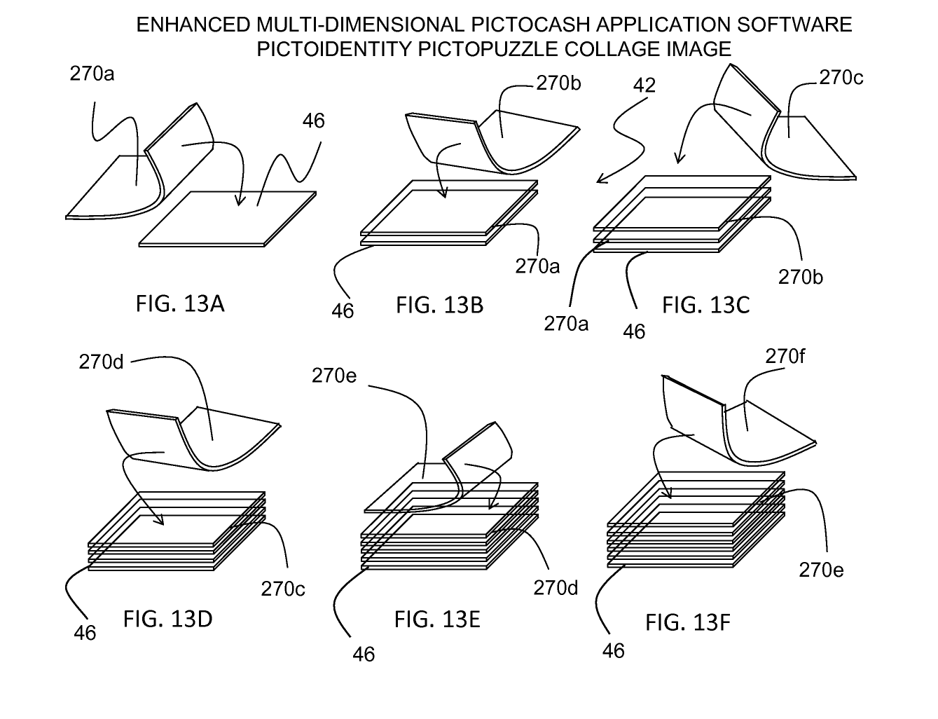

A Collage Image 42, as shown in a basic diagrammatic representation in FIGS. 13A-13F, is created from a set of PictoLayers 270a-270f that are aligned and layered on top of one another so that portions of images below show through the upper layers, forming a Collage or Decoupage pictorial image. Using the PictoOverlay Technology, the PictoLayers 44 are formed from Trans-Snips 33, Composite Images or PictoStorys 34 with each layer causing an increase in visual complexity as more pictorial elements are added. In this example, six layers 270a-270f are stacked one on top of one another and on top of the Selected Identifiable Image Trans-Snip 46 and because the layers are transparent the pictorial elements are seen through all of the layers. FIG. 13A shows a Collage Image 42 formed with the Selected Identifiable Image Trans-Snip 46 and with the layer 270a that has one or more pictorial images. With each added layer as shown in FIGS. 13b-13f, the visual complexity of the Collage Image 42 increases.

### Details of Module A: Randomization of the PictoIdentity PictoPuzzle

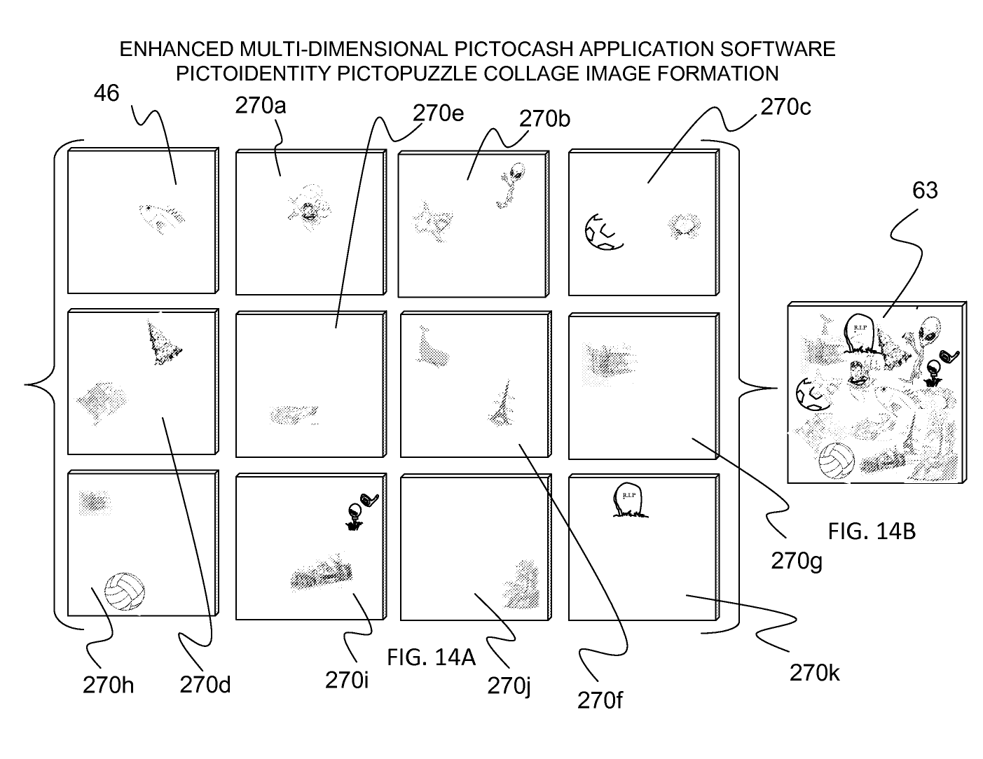

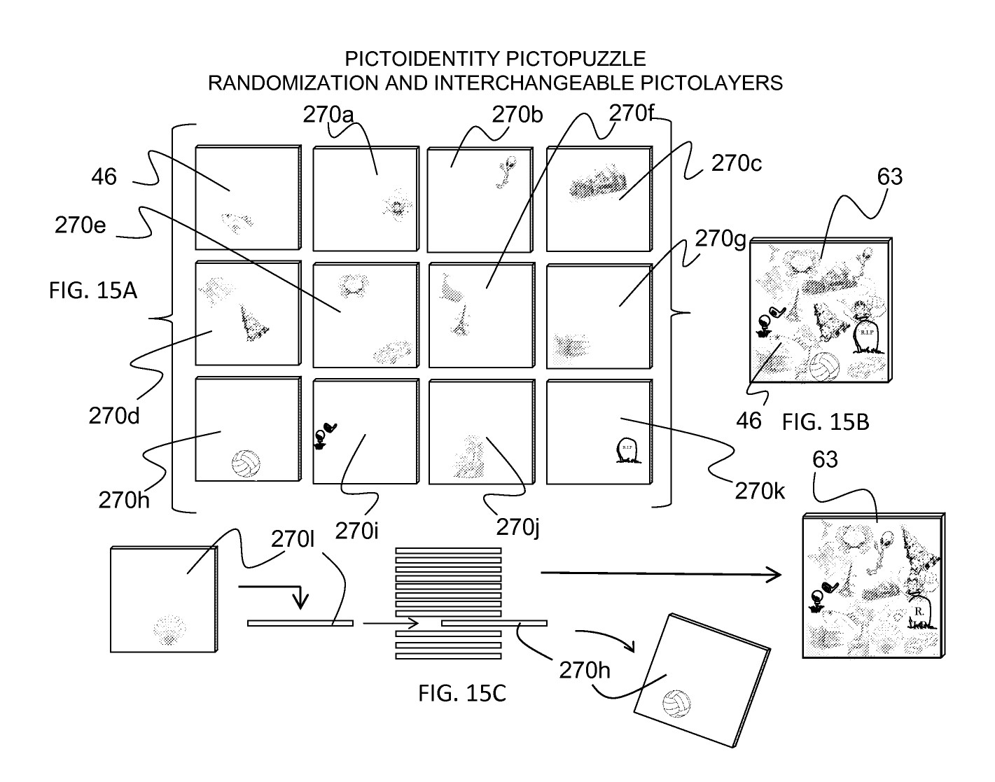

The Process Controller 38 activates and renders the Collage Image 42 to create the PictoIdentity PictoPuzzle 63 from the randomly selected and layered Trans-Snips 270a-270k and the Selected Identifiable Image Trans-Snip 46 as shown in FIGS. 14A and 14B. One or more Enhancements 64 may also be associated with the Trans-Snips 270a-270k and the Selected Identifiable Image Trans-Snip 46 to, in a first embodiment, present each layer of the PictoIdentity PictoPuzzle 63 in a delayed fashion to give the User sufficient time to identify their Selected Identifiable Image Trans-Snip 46 from the layered stack of Trans-Snips 270a-270k. Using the Random Generator 51, the Selected Identifiable Image Trans-Snip 46 is always randomly presented in different locations and orientations within the PictoIdentity PictoPuzzle 63, as shown in FIGS. 15A and 15B. In the PictoIdentity PictoPuzzle 63, as shown in FIG. 15B, the Selected Identifiable Image Trans-Snip 46 is positioned in a different location than was previously shown so the User must once again search the PictoIdentity PictoPuzzle 63 for their particular picture.

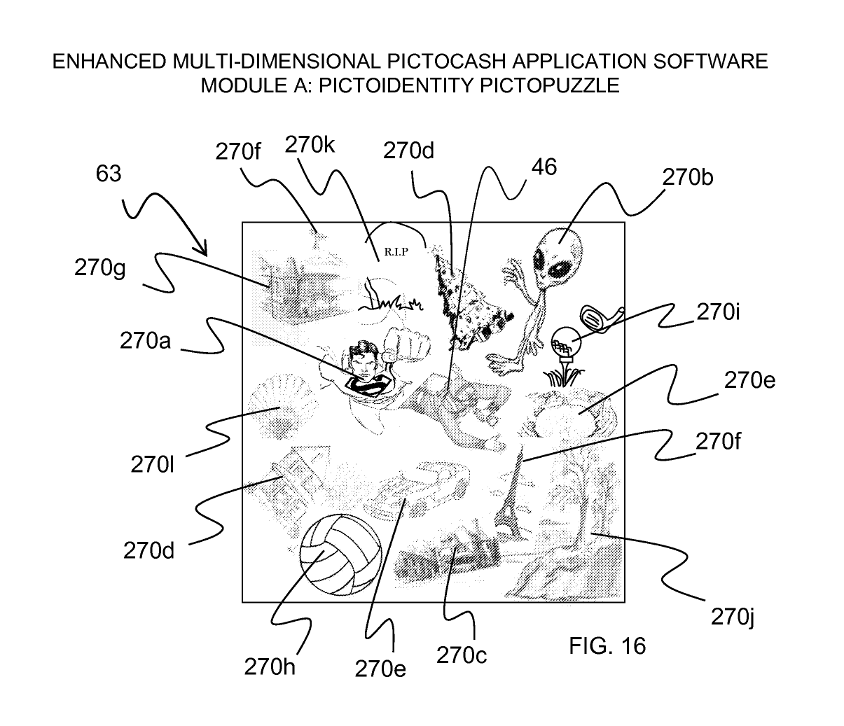

Additionally, using the Random Generator 51, the PictoIdentity PictoPuzzle 63 may be changed by replacing any number of PictoLayers 44 as shown in FIG. 15C. The Random Generator 51 selects an Alternative PictoLayer 2701 from the Variable Output Folder of the Data Store Resource 48 to be used to replace the Interchangeable PictoLayer 270h within the PictoIdentity PictoPuzzle 63. The Alternative PictoLayer 2701 is renamed to the encrypted Coordinate File Name matching the Interchangeable PictoLayer 270h and the PictoLayer 270h is replaced in the PictoIdentity PictoPuzzle 63. In this way every PictoIdentity PictoPuzzle 63 presented is different than a previous one. As shown in FIG. 16, the Selected Identifiable Image Trans-Snip 46 may also be a different portion of the Selected Identifiable Image 200 where in this example the Trans-Snip 46 is a portion of the Scuba Diver is shown. The User must therefore be familiar enough with their Image 200 to identify a different partial display presented as the Trans-Snip 46. The PictoIdentity 26 therefore requires the correct indication of one or more letters or numbers, the correct indication of the chosen Major Theme, the chosen Sub-Theme and the chosen Sub-Topic and the identification of Selected Identifiable Image Trans-Snip 46 within the PictoIdentity PictoPuzzle 63 which can all be done by simply selecting number on a keypad, using a touch screen or with a mouse or other pointer device

### PictoCash Account Application Software Computer Platform

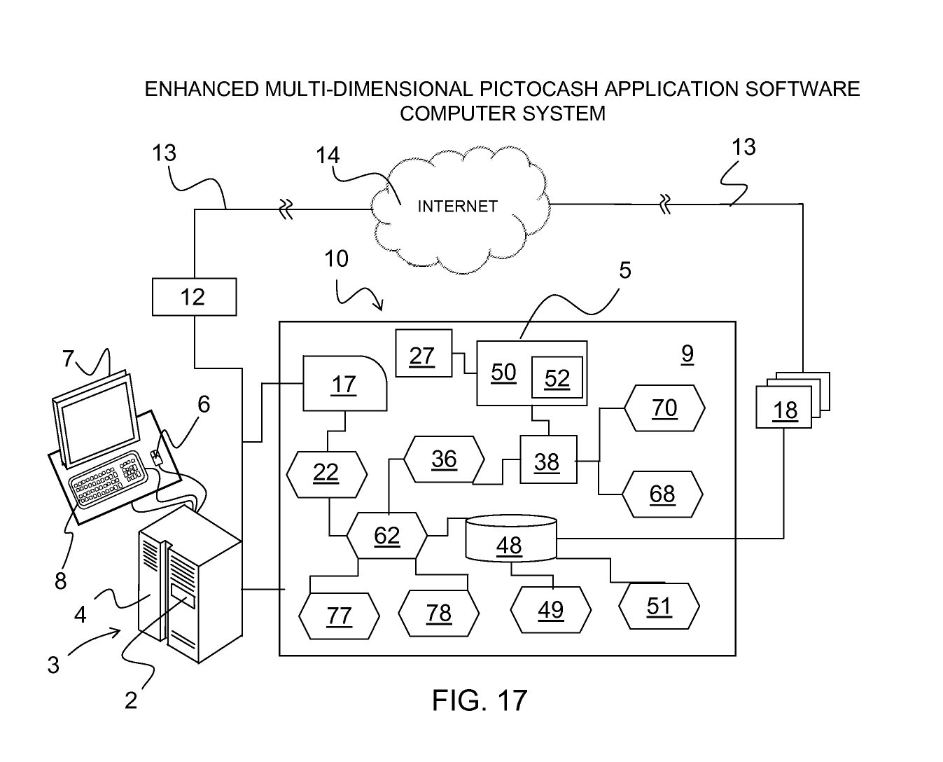

As shown in FIG. 17, in a first embodiment the Enhanced Multi-Dimensional PictoCash Application Software 10 may be implemented in computer hardware and computerized equipment. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a User to input information to a software program. As an alternative to using the keyboard 8 for input, a mouse 6 may be used for moving a selector on the display 7 and graphical user interface, or alternatively a touch screen input device may be provided for selecting an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area Network, such as the Internet. Still further, the processor unit 5 may be programmed, as is well known in the art, for storing the software program internally. A printer or other output device can also be connected to the processor unit 5 for printing a hardcopy of the display from the computer system. The processor unit 5 can have a Network connection 13, such as a telephone line, Network cable or wireless link, to an external Network, such as a local area Network or the Internet 14.

The output device 7 provides visually to the user transactional, interactive or variable data that has been Subject to transformations. The output device 7 can be a monitor or other visual computer screen or graphical user interface (GUI), a printer or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 can store a computer program or software application product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through application software 17 on a SaaS (Software as a Service) or on demand computing service such as a Cloud or shared resource database through a web browser. A secure login with password may be provided to remotely access the software 17 through an intranet or internet connection. One or more of the devices to access the application software may be connected wirelessly, such as by a cellular link, either directly or via a Network. It is to be appreciated that such devices can be mobile devices (e.g., PDA, iPod, iPad, tablet computer or smartphone that can be used as a processing unit, a display unit, or a unit to give processing instructions), and as a service offered via the World Wide Web.

In each context, the invention may stand alone or may be a component of a larger system solution. Furthermore, human interfaces, e.g., the input, the digital processing, the display to a user (if needed), the input of user requests or processing instructions (if needed), the output, can each be on the same or different devices and physical locations, and communication between the devices and locations can be via public or private Network connections, or media based communication. Where consistent with the foregoing disclosure of the present invention, the method of the invention can be fully automatic, may have user input (be fully or partially manual), may have user or operator review to accept/reject a result, or may be assisted by data or metadata (data or metadata that may be user supplied, supplied by another computer program or database from a different application or determined by an algorithm). Moreover, the algorithm(s) may interface with a variety of workflow user interface schemes.

In the following description, some features are described as “software”, “software programs”, or “software applications”. Those skilled in the art will recognize that the equivalent of such software can also be readily constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Implementation of the present invention may be in conjunction with one or more database management systems (DBMS) such as Oracle, IBM DB2, Microsoft SQL Server, PostageSQL, MySQL, or others using widely supported database languages such as SQL to define and manipulate data and perform data queries. Other aspects of such algorithms and apparatus, and hardware and/or software for producing and otherwise processing the data involved therewith, not specifically shown or described herein may be selected from any such systems, algorithms, components, and elements known in the art. The present invention may further be implemented on a secure web server 9 using SSL, SHTTP or other security protocols for encryption and decryption of transmitted data. Data replication and redundancy is performed automatically and all servers are secured in optimal conditions. Further security is provided where each story project is setup using a unique domain name that is accessible only using login identifications and passwords. User logins and preferences link specific user information to their user identification to provide predetermined access to information for each user. Administrative tools within the PictoCash Management Entity 86 monitor, add or remove users, manage content and set restrictive/predetermined access parameters to users of the system. In developing the PictoCash Account 20 on different platforms and media formats, the PictoCash Application Software 10 provides access to setup and use a PictoCash Account 20 through an App on a mobile device or through an internet connection to a personal computer or other electronic device.

### Module B: Architectural Blueprint PictoCash Account Page

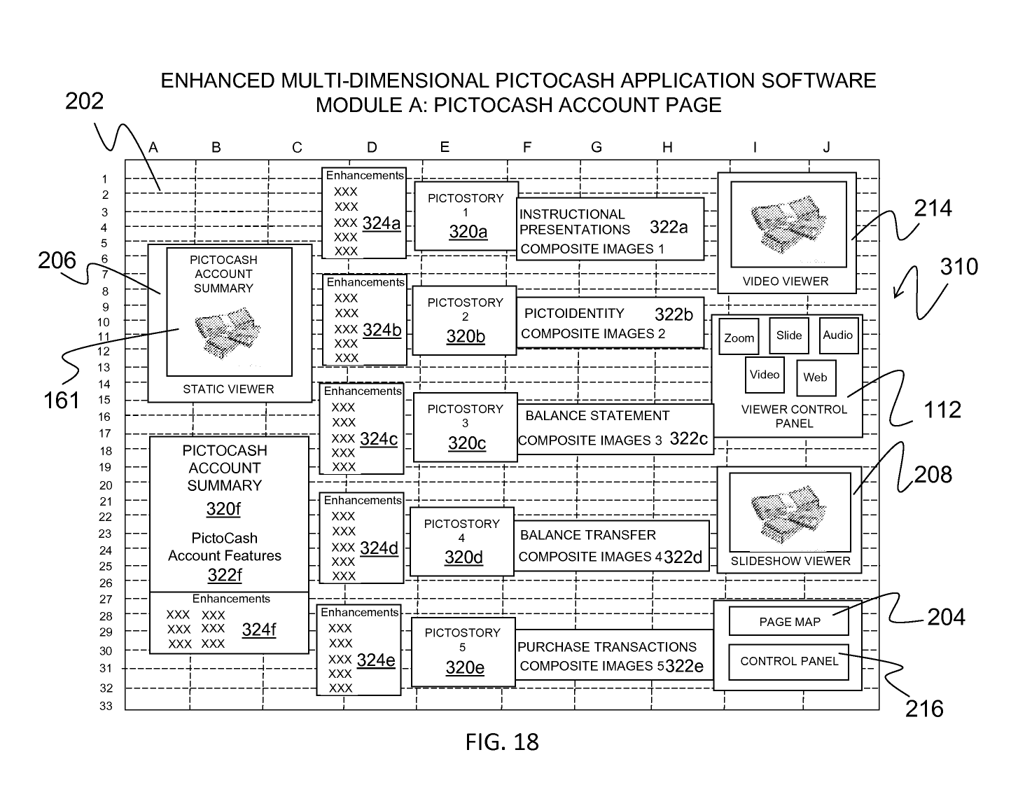

Using the Production Populator 36 of Module B, the Instructional Presentations PictoStory 320a with the Components and Sub-Components 322a for the Introduction, Explanation and Navigation Presentations 28 and the PictoIdentity PictoStory 322b with the Components and Sub-Components 322b of the PictoIdentity 26 populate the PictoCash Account Architectural Blueprint 310, as shown in FIG. 18. Additional features of the PictoCash Account for Balance Statements 320c, Balance Transfers 320d and Purchase Transactions 320e are structured and formatted within the PictoCash Account Blueprint 310 with the Composite Images 322c-322e and other Components and Sub-Components. The PictoCash Account Blueprint 310 provides a workspace for the construction and modification of features of the PictoCash Account 20. The PictoStorys 320a-320f including a Summary PictoStory are further associated with Enhancements 324a-324f using the Enhancements Generator 62 and Process Controller 38 of the PictoCash Account Production Tools 27 to create interactive features for a User to setup and use the PictoCash Account 20. The features are formed from the PictoStorys 320a-320f that are created from an applied KeyConcept Querys 40 to develop the display and controls required to present in Module C the general status of the account including the account balance and a list of transactions and transfers using the Balance Statement PictoStory Page 320c. The Balance Transfer PictoStory Page 320d provides interactive controls for the User to request a transfer code to transfer PictoCash out of a PictoCash Account 20 to another PictoCash Account. Conversion of PictoCash to actual cash is not allowed within the PictoCash Network 100 and Management Entity 86. The Purchase Transactions PictoStory Page 320e provides the tools for the User to access PictoGames 98 and other mini-apps within the PictoCash Network 100 to make purchases, perform software downloads and uploads, add minutes for mobile devices and perform other transactions. Additional features may provide for access to Consumer Products 99 offered from Authorized Dealers 94 that may be purchased using PictoCash. The Summary PictoStory 320f is also presented within the PictoCash Account Page 310 to provide an overview of the features of the PictoCash Account 20.

The PictoStorys are located within the Reference Page Cell Map 202 of the PictoCash Account Page 310 within the Architectural Blueprint 52. The PictoCash Account Process Controller 38 is used to create, navigate, order, modify, enhance, edit, playback, review, combine, render, realize and activate the PictoStorys to display and make the features of the PictoCash Account 20 accessible for a User. The PictoStorys are accessible using the three viewers to view the PictoStory, the Static Control Viewer 206, the Slide Show Viewer 208 and a Video Viewer 214. The layered PictoCash Summary Composite Image 322f is shown statically and enlarged in the Control Viewer 206 for review and editing of its PictoLayers 44 and Components including the Enhancements 324f associated with the Composite Image 322f.

### Module B: Enhancements

In this first embodiment of the PictoCash Account Page 310, as shown in FIG. 18, the Architectural Blueprint 52 provides a workspace for the Process Controller 38 and Enhancements Generator 62 to modify and associate Enhancements 64 with the PictoLayers of the PictoCash Account 20. These Enhancements 64 and the Enhancements 324a-324f of the other PictoStory Pages are accessed using their coordinate locations on the Referenced Page Cell Map 202 and are represented as X's. As shown, any PictoLayer 44 may have multiple Enhancements 64 and access to the Enhancements 64 are designated within the Referenced Page Cell Map 202 of the PictoCash Account PictoStory as activation points, navigation buttons, hyperlinks or other markers that when selected run the Enhancement 64. Enhancements 64 provide the audio and video effects for timing, sequencing, interaction and presentation of the PictoCash Account 20. Associated at any of the Multi-Dimensional levels within any one PictoLayer 44 or multiple PictoLayers 44 or any Component or Sub-Components at one cell of a combination of cells, or any blank portion of the Transparent Page or populated portion of a PictoLayer 44 may activate the Enhancement 64.

Enhancements 64 by definition can be any further automated amplification, pictorial expansion, or transition to a Sub-routine or indeed totally different URL or a fully interactive application that is activated and referenced by selecting a button, clicking a mouse, touching a screen or using any other operational control at the appropriate cell mapped reference points in accessing the PictoCash Account 20. The Enhancement 64 may be in numerous forms, including inter alia: Text, Narration, Music, Song, Slides, Animation, Calculations, etc. with interactive tools for navigation and data entry where required.

In a first embodiment, the series of PictoCash Account PictoStorys 320a-320f are constructed from Composite Images 322a-322f related to the features of the PictoCash Account 20 using the PictoComposite Generator 78. Using the Enhancements Generator 62, Enhancements 324a-324f react to the instructions and commands provided by a User in accessing the PictoCash Account 20. For example, each time a transaction within the PictoCash Account 20 is requested, the PictoIdentity 26 is displayed for the User to complete and verify the transaction. The PictoLayers 44 of the PictoIdentity 26 are enhanced to dynamically present the PictoIdentity PictoPuzzle 63 and to display other account maintenance and transactional features of the PictoCash Account 20. Enhancements 64 may be in any media format and are associated to the PictoLayers 44 through Hyperlinks, Sub-routines, Macros, Scripts and other software applications to provide Animation, Text, Music, Narration Text, Audio, Audio Narration, Sound Effects, Video, Visual Effects and other features. The Enhancements 64 are categorized and stored in the Data Store Resource 48.

An important feature of the PictoOverlay Technology is the use of Dynamic HTML with any PictoLayer, Page, Collage Image, PictoStory, Composite Image, Trans-Snip or any combination of each of these Components and Sub-Components. Using Dynamic HTML, a timing and sequence dimension may be added to the PictoLayers 44 to display each layer at different times, and in different orientations to create movement or provide a sequence to displayed events. Visual effects using D-HTML or other coded sub-routines may further be introduced to accentuate the visual image by zooming, panning, changing colors or focus or other features of the PictoLayer 44. Global visual effects may also link, order and sequence the PictoLayers with timing and structure to dynamically present each feature of the PictoIdentity 26 and the PictoCash Account 20. For example, dynamic Multi-Dimensional Film-Like PictoStory Presentations for products available for purchase within the PictoCash Network 100 may be created to entice and inform a consumer on the product's value and features. Using the Trans-Snips 74, Composite Images 76 and Enhancements 64 an advertisement or dynamic product information sheet may be created from a few product pictures at much lower cost than conventional online or print advertisements. Using the PictoCash Account Random Generator 51 the advertisements may be easily changed by seamlessly replacing PictoLayers within the Advertisement Presentation.

### Module B: PictoCash Software Application Referenced Page Map

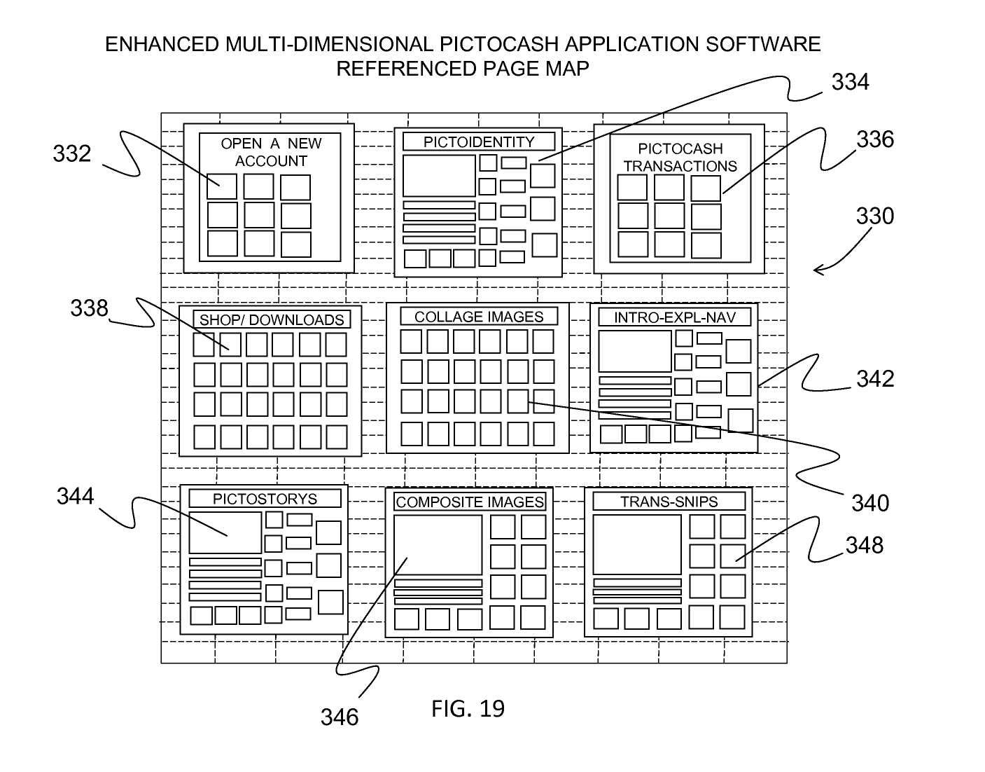

The Referenced Page Map 204 provides navigation to access each PictoStory Page and the PictoLayers 44 that make up that Page. Pages within the Referenced Page Map 204 are accessible by zooming in or out of the Map 204, not by scrolling. All features within the PictoCash Account 20 are displayed and navigated to using a three-dimensional coordinate system where the location of a Montage Page or PictoStory has a row and column coordinate, and the level of each PictoLayer 44 has a Z coordinate and in this manner any Page may be navigated to by simply selecting the Composite Image 76 within the Referenced Page Map 204 to move to that coordinate. In this diagrammatic representation as shown in FIG. 19, Pages within the PictoCash Account that are accessible by the Referenced Page Map 204 may be a Montage Page to Open a New Account 332, the PictoIdentity Page 334, and the Transactions Montage Page 336 to access features within the PictoCash Account 20. The Referenced Page Map 204 displays and provides access to every Multi-Dimensional level of the PictoCash Account 20 including access to the PictoGame Products 338 within the PictoCash Network 100 to Shop and Perform Software Downloads, access to Collage Images 340 that may be used randomly in the PictoIdentity PictoPuzzle 63 and access to the Introduction, Explanation and Navigation Presentations 342. Access may also be provided to the PictoStorys 344, to the Composite Images 346 and to the Trans-Snips 348 that are all directly accessible to modify and enhance each PictoLayer 44 using the workspace of the Architectural Blueprint 52 and Process Controller 38 and PictoCash Production Tools 27 of Module B.

The PictoCash Production Tools 27 renders and activates all or a portion of the Enhanced Multi-Dimensional PictoCash Account 20 features. The rendering of the PictoStorys 320a-320f activates the associated Enhancements 324a-324f to run any Subroutine, Software Application, URL, linkage, or other types of file formats to dynamically present and activate the PictoStorys 320a-320f for a User to interact with the PictoCash Account 20. The Enhancements 324a-324f may be associated with any of the PictoLayers 44 including a Collage Image 42, a PictoStory 34, a Composite Image 35 or a Trans-Snip 33. Access to these PictoLayers 44 and their Components and Sub-Components within the Architectural Blueprint 52 is not provided to the User.

### Module C: Features of the PictoCash Production Presenter

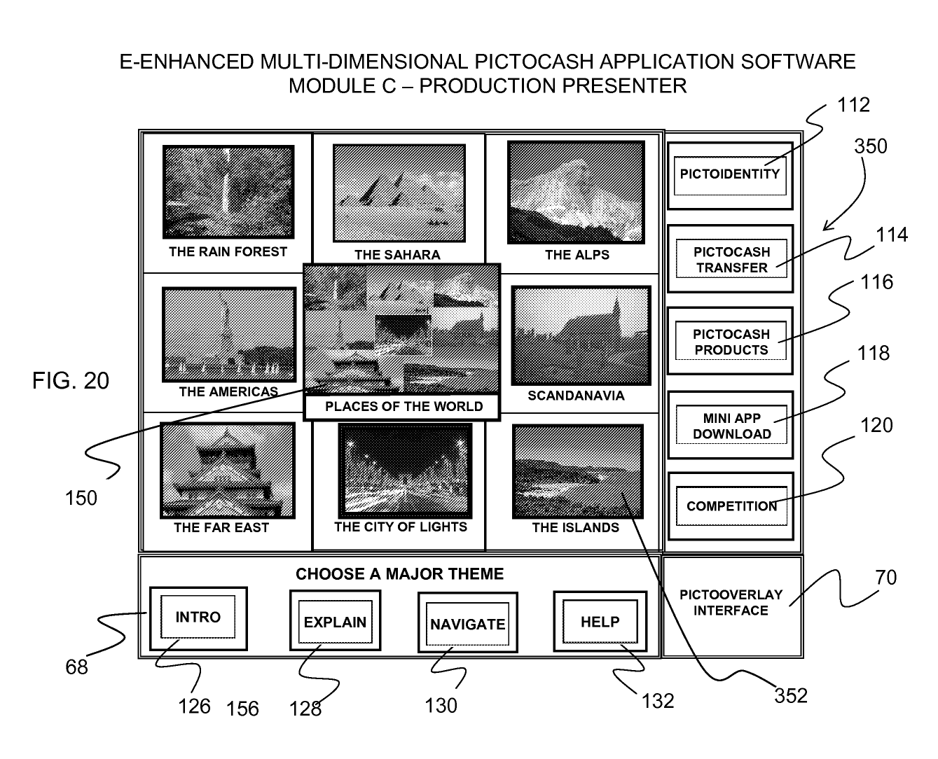

As shown in FIG. 20, the User upon entering the PictoCash Account 20 may see the Major Theme Montage Page 140 and a series of control panels. Access to the controls to activate the Introduction Presentation 126, the Explanation Presentation 128 and the Navigation Presentation 130 and a Help display is provided using the Production Presenter 68 to provide an overview of the features of the PictoCash Account 20 and present instruction on how to use and navigate through those features. The Instructional Presentations 28 also present instruction on creating and using the PictoIdentity 26 and present other features of the PictoCash Account 20 through a Multi-Dimensional Interactive Film-Like Presentation.

### Module C: Creating and Using the PictoIdentity

In order to access the PictoCash Account 20 or perform any transaction within the PictoCash Network 100, the PictoIdentity 26 must be completed to verify and confirm the User's request for the transaction. In a first embodiment as described herein, the PictoIdentity 26 is developed by the User by first deciding on a letter or number from the Alphanumeric Block 122 that may have the twenty-six letters of the English alphabet and the digits 0-9. Once the letter or number is chosen, the User may simply enter the letter or number from a keypad or touchscreen display when prompted to initiate the PictoIdentity 26. The Alphanumeric Block 122 therefore is not required to be displayed. Instead as shown in FIG. 20, the Major Theme Montage Page 140 may be displayed for the User to identify their chosen labeled picture representing the Major Theme. In this example, the General Major Theme is Places around the World 150 and the Chosen Major Theme 352 may be the picture displaying the scenic vista of a sprawling beach labeled The Islands. By choosing the correct picture or by choosing the correct picture and the PictoIdentity Control Button 112 the choice may be entered. A second Montage Page is displayed showing the labeled pictures for the Sub-Theme for the User to identify their chosen picture. The Sub-Themes may show labeled pictures of people in different occupations, such as a chef, scuba diver, mountain climber and others. The User identifies their picture and chooses the PictoIdentity Control Button 112 to enter their choice. The User may have chosen the Scuba Diver because there is some association between the Major Theme and Sub-Theme and may be more easily remembered, who may choose any other Sub-Theme where there is no relationship or perhaps a personal relationship, such as choosing the chef labeled because of a great meal that was had when visiting the islands. The Sub-Topic Montage Page may then be displayed with labeled pictures of different objects and the User identifies their chosen Sub-Topic labeled picture. By associating the label with the picture the chosen Major Theme, Sub-Theme and Sub-Topic may be more easily remembered with each choice being unique to the individual User.

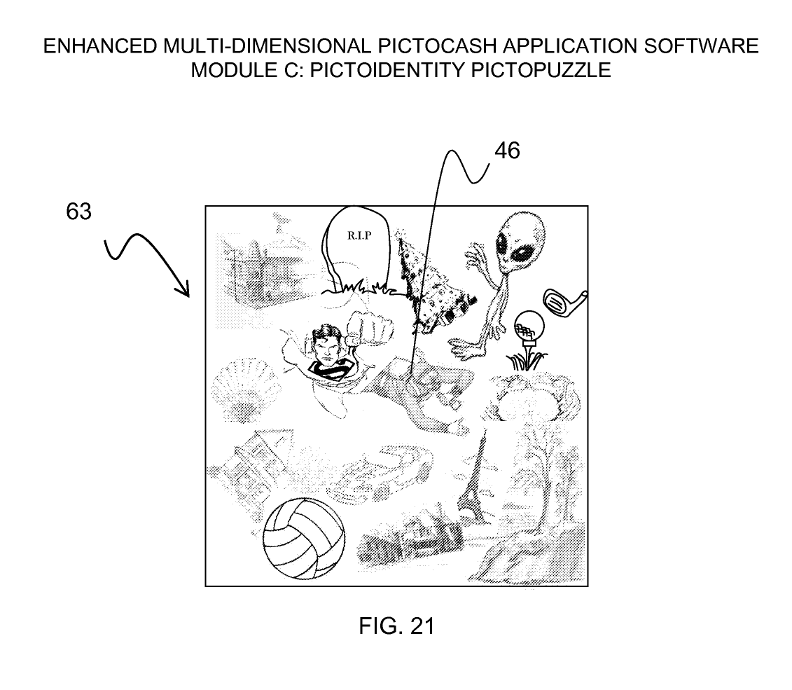

The Theme pictures must be chosen correctly and in the correct order with each choice increasing the complexity of the PictoIdentity 26. The PictoIdentity PictoPuzzle 63 is then displayed as shown diagrammatically in FIG. 21, with the Selected Identifiable Image Trans-Snip 46 that shows only a portion of the Selected Identifiable Image 200 within a PictoPuzzle. Each Trans-Snip 270 may be presented separately and appear on the screen for a short period of time such as a quarter to one-half of a second, to give the User enough time to view and identify their image and select it within the PictoPuzzle 63. The User must identify the Image Trans-Snip 46 using a keypad, touch screen mouse or other indicator to complete the PictoIdentity 26 and authorize a transaction. If for example, the User wants to purchase or continue playing a PictoGame or mini-app upon completion of the PictoIdentity 26, the PictoCash Entity Management System then transfers the appropriate amount of PictoCash out of the account as a fee for the game. Alternatively, the PictoCash Account 20 may have minutes that are transferred out of the account for each minute the User accesses the mini-app. The User is not required to do anything more than complete the PictoIdentity 26 correctly to authorize the transaction and because there is no personal information associated with the PictoCash Account, information about the transaction is also protected so no personal information is available or disclosed for data mining thereby preventing retailers from tracking, suggesting or spamming a User based on their online purchases.

A unique PictoIdentity 26 is developed by the User for each PictoCash Account 20 on a specific mobile or electronic Resident User Device 84. The unique PictoIdentity 26 may be used to access specific features within a website, view PictoCash Products 116 and complete transactions and purchase with the PictoCash Management Entity or an Authorized Dealer 94 on the PictoCash Network 100, or download or upload specific software applications 118. The PictoIdentity 26 may include in addition to the Selected Identifiable Image Trans-Snip 46, an identifying feature or image that communicates to the User the specific Authorized Dealer 94 they are purchasing from. For example, a trademark or icon from the Authorized Dealer 94 may be randomly jumbled within the PictoIdentity PictoPuzzle 63 to identify that the transaction is related to a specific retail purchase from that entity within the PictoCash Network 100. Failure to correctly complete the PictoIdentity 26 or insufficient PictoCash within the account will stop the purchase transaction or the download of a PictoGame or mini-app 118 and the User will be prompted to replenish funds in the PictoCash Account 20. The funds may be replenished through a retail purchase from a PictoCash Retailer 80 where a monetary sum is converted to PictoCash. Funds may also be accrued through the playing of PictoGames or other mini-apps high scores or low scores may add or subtract from the PictoCash Account 20 either individually or in an online competition 120. Funds may also be transferred from one PictoCash Account 20 to another by requesting a Transfer Code 90 from the PictoCash Management Entity 86 as described herein. The Transfer Code 90 may be entered by the User on another Resident User Device 84 that has a different PictoCash Account 20 or be emailed to another User for them to enter into their PictoCash Account 20 to transfer the PictoCash. A PictoIdentity 26 must be completed to verify and confirm the transfer. Using this exclusive security protocol, the level of protection is dramatically increased over login, password or other protection systems that require the User to remember an elaborate configuration of letters and numbers or perform multiple steps and keystrokes to complete a transaction.

### Module C: The PictoOverlay Interface

The PictoCash Entity Management System 86 manages the PictoCash Network 100 and provides PictoGames 98, other video gaming applications, music, videos and other products for a User to download or access within the PictoCash Network 100. Payment for the download or access is made using the PictoCash within the PictoCash Account 20 and each transaction is verified using the exclusive PictoIdentity 26. The PictoCash Account PictoOverlay Interface (POI) Display Screen 350, shown diagrammatically in FIG. 20, provides access to the PictoCash Account 20 with optional selection buttons to select the Instructional Presentations 28, to Transfer PictoCash 114, to view available Products 116 on the PictoCash Network 100, to Download Mini-Apps 118 and Enter Competitions 120. Performing transactions using the PictoCash Account is easy with succinct, comprehensive pictorial overviews of how to setup and use the PictoCash Account 20 from the Introduction 126, Explanation 128 and Navigation 130 Presentations to provide a User. The Presentations 28 also provide an overview of how to setup the completely unique and personal PictoIdentity 26 that may be used to perform the secure transactions within the PictoCash Network 100. To complete any purchase transaction or balance transfer, the User must enter the easily remembered and secure PictoIdentity 26 to complete the transaction. By simply performing a few keystrokes, the User completes the transaction without the necessity to remember a login name, a password of an elaborate series of letters and numbers, or have a card and read off a credit card number that may be seen or overheard. The PictoCash Account 20 maintains account balances and statements showing each transaction with each entity within the PictoCash Network 100 and provides for purchase and the transfer of funds.

The invention has been described in detail with particular reference to certain preferred embodiments thereof, but it will be understood that variations and modifications can be effected within the spirit and scope of the invention. The claims should not be read as limited to the described order or elements unless stated to that effect. Therefore, all embodiments that come within the scope and spirit of the following claims and equivalents thereto are claimed as the invention.

What is claimed is:

1. An account management software system and apparatus, comprising:
application software installed on a computer system;
the application software further comprising;
a pictopuzzle generator;
a pictolayer generator;
a pictocomposite generator;
an enhancements generator;
an architectural blueprint; and
a repository having points representing a monetary value; and
wherein the points are accessible to perform a financial transaction by completing a pictoidentity.

2. The account management software system and apparatus of claim 1, wherein the completion of the pictoidentity comprises the identification of one of at least a letter, a number, a static picture, and a trans-snip dynamically presented in a pictopuzzle.

3. The account management software system and apparatus of claim 2, wherein the trans-snip is formed from a portion of an identifiable image.

4. The account management software system and apparatus of claim 3, wherein the pictopuzzle is formed from a plurality of pictolayers and the trans-snip formed from a portion of an identifiable image using the pictopuzzle generator.

5. The account management software system and apparatus of claim 4, wherein the plurality of pictolayers are formed from one of at least a trans-snip, a composite image and a pictostory.

6. The account management software system and apparatus of claim 4 further comprising a random generator for the selection of at least one alternative pictolayer to be used to replace at least one active pictolayer within the pictopuzzle.

7. The account management software system and apparatus of claim 6 wherein the at least one alternative pictolayer is renamed with a coordinate file name of at least one active pictolayer and the active pictolayer is replaced with the alternative pictolayer in the pictopuzzle.

8. The account management software system and apparatus of claim 1 wherein an account is associated with the repository and an electronic device.

9. The account management software system and apparatus of claim 7, wherein the application software prevents the transmission of personal information associated with the user of the electronic device.

10. The account management software system and apparatus of claim 1 wherein the financial transaction is one of at least a download of a software application, a purchase of minutes for a mobile device, and a product purchase.

11. The account management software system and apparatus of claim 1 further comprising one of at least an introduction presentation, an explanation presentation and a navigation presentation.

12. A method of securely authorizing a purchase transaction, comprising the steps of:
accessing application software installed on a computer system;
creating a pictoidentity, comprising;
choosing at least one alphanumeric value;
choosing at least one static picture;
selecting an image;
creating a trans-snip from the image;
creating a collage image that includes the trans-snip of the selected image and other trans-snips from a plurality of images;
adding value points to a repository;
authorizing a purchase using the value points by completing the pictoidentity.

13. The method of securely authorizing a purchase transaction of claim 12, further comprising the step of completing the pictoidentity by identifying at least one of the chosen alphanumeric value, the chosen static picture, and the trans-snip of the selected image from within a dynamic presentation of the collage image.

14. The method of securely authorizing a purchase transaction of claim 13, further comprising the step of replacing at least one of the other trans-snips from the plurality of images in the dynamically presented collage image.

15. The method of securely authorizing a purchase transaction of claim 12, further comprising the step of completing the pictoidentity by using a keypad of a small cellular telephone.

16. The method of securely authorizing a purchase transaction of claim 12, further comprising the step of completing the pictoidentity by using a touchscreen.

17. The method of securely authorizing a purchase transaction of claim 12, further comprising the step of associating an account for the repository with an electronic device.

18. The method of securely authorizing a purchase transaction of claim 17, further comprising the step of preventing electronic transmission of personal information associated with the user of the electronic device.

19. The method of securely authorizing a purchase transaction of claim 17, further comprising the step of accessing the account using only the pictoidentity.
